(19) United States
(12) Patent Application Publication
(10) Pub. No.: US 2012/0150733 A1
(43) Pub. Date: Jun. 14, 2012

(54) Ecological impact compliance

(75) Inventors: Christian Belady, Mercer Island, WA (US); Rob Bernard, Redmond, WA (US); Angel Sarmento Calvo, Redmond, WA (US); Larry Cochrane, Redmond, WA (US); Jason Garms, Redmond, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Jennifer Mame Pollard, Redmond, WA (US); John D. Rinaldo, JR., Bellevue, WA (US); Clarence T. Tegreene, Bellevue, WA (US); Rene A. Vega, Scotts Valley, CA (US); Lowell L. Wood, JR., Bellevue, WA (US); Feng Zhao, Redmond, WA (US)

(73) Assignee: Elwha LLC, a limited liability corporation of the State of Delaware

(21) Appl. No.: 13/317,728

(22) Filed: Oct. 26, 2011

Related U.S. Application Data
(63) Continuation-in-part of application No. 12/928,638, filed on Dec. 14, 2010.
Application No. 12/928,638 is a continuation-in-part of application No. 13/135,674, filed on Jul. 12, 2011.
Application No. 13/135,674 is a continuation-in-part of application No. 13/135,683, filed on Jul. 12, 2011.
Application No. 13/135,683 is a continuation-in-part of application No. 13/199,475, filed on Aug. 31, 2011.
Application No. 13/199,475 is a continuation-in-part of application No. 13/199,476, filed on Aug. 31, 2011.
Application No. 13/199,476 is a continuation-in-part of application No. 13/199,995, filed on Sep. 14, 2011.
Application No. 13/199,995 is a continuation-in-part of application No. 13/200,809, filed on Sep. 30, 2011.
Application No. 13/200,809 is a continuation-in-part of application No. 13/200,807, filed on Sep. 30, 2011.

(51) Int. Cl. G06Q 99/00; G06Q 40/00

(52) U.S. Cl. 705/39; 705/317

(57) ABSTRACT

Systems and methods for providing ecological impact quantification identifiers may implement operations including, but not limited to computing at least one ecological impact quantification associated with at least one life-cycle phase of a product; and means for assigning at least one of a positive ecological impact status, a negative ecological impact status and a neutral ecological impact status with a user account according to the at least one ecological impact quantification.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/928,638, entitled LIFECYCLE IMPACT INDICATORS, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed 14 Dec. 2010, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/135,674 having an entitled EFFICIENCY-OF-USE TECHNIQUES, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Jul. 12, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/135,683 entitled USER AS PART OF A SUPPLY CHAIN, naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Jul. 12, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/199,475, entitled EFFICIENCY OF USE OF A SHARED PRODUCT naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Aug. 31, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/199,476, entitled ECOLOGICAL IMPACT QUANTIFICATION IDENTIFIERS naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Aug. 31, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/199,995, entitled MONITORING EFFICIENCY AND ECOLOGICAL IMPACT ASSOClATED WITH A USE OF A PRODUCT naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Sep. 14, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/200,809, entitled PUBLICATION OF EFFICIENCY AND ECOLOGICAL IMPACT DATA TO A SOClAL MEDIA INTERFACE naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Sep. 30, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/200,807, entitled DISPOSAL MODE ECOLOGICAL IMPACT MONITORING naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Sep. 30, 2011, which is currently co-pending or is an application of which a currently co-pending application is entitled to the benefit of the filing date.

For purposes of the USPTO extra-statutory requirements, the present application constitutes a continuation-in-part of the United States patent application having attorney docket number 0109-003-022-000000, entitled EFFICIENCY OF USE OF A COMMON PRODUCT naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Oct. 26, 2011, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

Systems, methods, computer-readable storage mediums including computer-readable instructions and/or circuitry for monitoring compliance of the ecological impact of a product with a regulatory standard may implement operations including, but not limited to: computing at least one ecological impact quantification associated with at least one life-cycle phase of a product; and means for assigning at least one of a positive ecological impact status, a negative ecological impact status and a neutral ecological impact status with a user account according to the at least one ecological impact quantification.

In one or more various aspects, related systems include but are not limited to circuitry and/or programming for affecting the herein referenced aspects; the circuitry and/or programming can be virtually any combination of hardware, software, and/or firmware configured to affect the herein referenced method aspects depending upon the design choices of the system designer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level illustration of an operational environment.

FIG. 2 shows a high-level illustration of an exemplary system.

FIG. 3 shows a high-level illustration of an exemplary system.

FIG. 4 shows a high-level illustration of an exemplary system.

FIG. 5 shows a high-level illustration of an exemplary system.

FIG. 6 shows an operational procedure.

FIGS. 7-15 show alternative embodiments of the operational procedure of FIG. 6.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The consumption of rare materials and the ecological impact caused by human behavior are both becoming serious problems for the Earth. For example, some experts estimate that our use of the ecosystem to obtain food, timber, energy, exceeds the planet's ability to provide. As if the scarcity of resources was not enough of a problem, human behavior is also causing increasing amounts of greenhouse gasses to be emitted into the atmosphere. Certain greenhouse gasses, such as carbon monoxide, sulfur dioxide, chlorofluorocarbons (CFCs) and nitrogen oxides, are generated by manufacturing, using, and disposing of products and the general consensus is that these greenhouse gases cause harm to the environment. For example, according to the 2007 Fourth Assessment Report by the Intergovernmental Panel on Climate Change (IPCC), greenhouse gases have caused the global surface temperature increased 0.74±0.18 C (1.33±0.32 F) during the 20th century. Climate models project that the temperature will increase another 1.1 to 6.4 C (2.0 to 11.5 F) during the 21st century. It is likely that this increase in temperature is a significant problem for living creatures. For example, the living planet index, which is an indicator of the state of global biological diversity, shows that between the period of 1970 and 2003 biodiversity fell 30 percent.

While the demand for products is causing significant damage to the environment, most people are complacent. People generally indicate that they care about the environment; however, people typically do not act in an environment friendly way because they are not aware of how their actions truly affect the environment. One reason for this may be that impact is too abstract to appreciate. For example, a person may recognize that driving a car causes harm to the environment; however, the person may not appreciate how much harm it causes because the person does not have to face any immediate penalty for driving nor does the person have to perceive any recognizable link between their behavior and the damage caused.

Accordingly, robust methods, systems, and computer program products are provided to, among other things, bring about an operational system wherein users can perceive how consumption behavior affects the environment. In an exemplary embodiment, ecological impact associated with products can be quantized, e.g., mapped to a discrete set of numbers (−99 to 99), or mapped to an abstract scale, e.g., “awful,” “bad,” “neutral,” “good,” and “exceptional” to express the impact these products have had and/or will have on the environment. Such ecological impact quantifications can be generated by an ecological impact regulation entity (e.g. a governmental agency such as the U.S. Environmental Protection Agency, the U.S. Food and Drug Agency, etc.) tasked with monitoring the compliance of the ecological impact of such products with legislative and/or regulatory standards or corporate entity (e.g. a product retailer such as Wal-Mart®, Target®, Apple®, Microsoft®, etc.) desirous of maintaining ecological impact standards on suppliers/vendors based on information associated with the composition, manufacturing, use and/or disposal of a product. The ecological-impact quantifications can be calculated for one or more stages of a product's lifecycle and/or for one or more disposal modes for the product. In at least one example embodiment, the ecological-impact quantifications for a product (or information based at least in part on the quantifications) may be computed to understand how much estimated harm the product has caused to the environment (e.g., from the mere fact that it was created) and/or how much harm the product can potentially cause when it is disposed of. The ecological-impact quantifications may be generated by the regulatory entity which may review the ecological impact quantification for compliance with one or more regulations established by the regulatory entity.

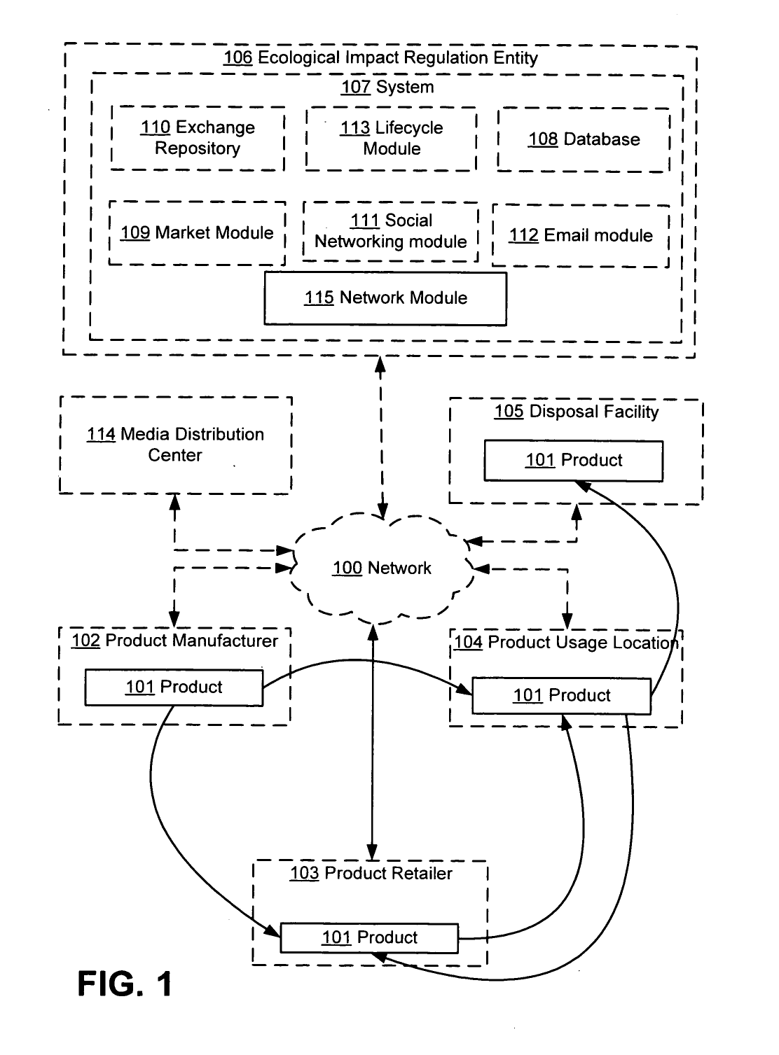

Referring now to FIG. 1, it illustrates a high-level block diagram of an exemplary operational environment that can be used to describe embodiments of the present disclosure. The arrows in dashed lines illustrate how a product can move through different locations throughout its life. The block-elements indicated in dashed lines are indicative of the fact that they are considered optional.

Each location within FIG. 1 can be interconnected via network 100, which may be the Internet. Each location can connect to network 100 using an access method such as, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks.

FIG. 1 illustrates various points in the lifecycle of a product 101, (e.g., an appliance, vehicle, electronic device, food-services item, etc.). At some point in time, product 101 can be manufactured by product manufacturer 102. For example, a company can purchase raw materials and/or manufactured materials and create product 101. After product 101 is manufactured, it can be optionally transported to product retailer 103 to be sold to a user (or sold directly to a user) or to a rental company such as a rental car company, an equipment rental company, a leasing center, etc., and transported to product usage location 104, e.g., a user's home, an office, a city, etc. The user can use the product, resell product 101 to product retailer 103 (or another product retailer), donate product 101 (not shown), or sell product 101 to another user (not shown). During the use phase of product 101, one or more efficiency-of-use scores can be computed that reflect whether product 101 is being used or was used efficiently. For example, each time product 101 is used, product 101 can compute an ecological impact quantification that is based on how product 101 was used as compared to a standard or as compared to the use of other users. In an exemplary embodiment, the efficiency-or-use can be numerical value, and lower scores can reflect more efficient use.

A product 101 can be resold to product retailer 103 (or another product retailer), donated (not shown), or sold to another user (not shown). Eventually, product 101 will be fully consumed, i.e., used up, broken, etc., and can be disposed of. A product 101 can be transported to a product disposal facility 105, e.g., landfill, recycling facility, incineration facility, etc., where it can be disposed of.

In an exemplary embodiment, an ecological impact regulation entity 106 can generate ecological impact quantifications associated with the product 101 and communicate them (or information based on them) to users at different points in the lifecycle of product 101. The ecological impact regulation entity 106 may provide monitoring services associated with tracking ecological impact of the product 101 and provide that information to entities at various points in the product lifecycle so that the efficiency and/or ecological impact of the use of the product 101 can be evaluated.

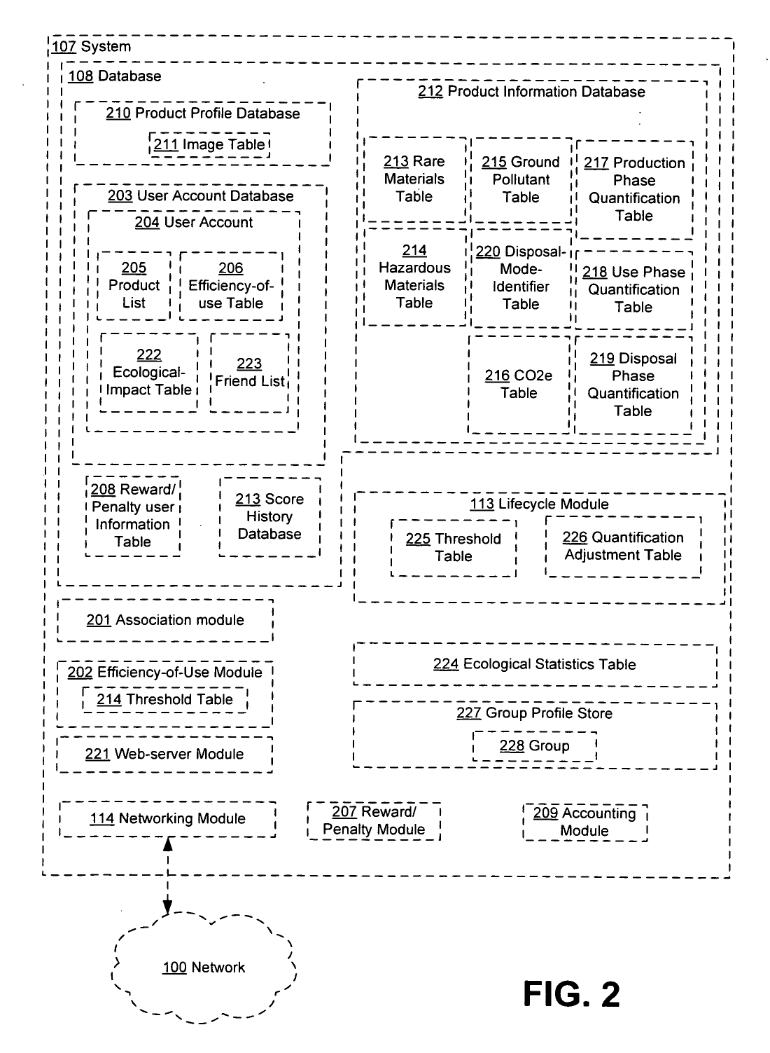

For example, ecological impact regulation entity 106 can include system 107, which can include one or more computer systems having processors, memory, operating system software, network adaptors, circuitry, etc. As shown by the figure, system 107 can include database 108, which is described in more detail in FIG. 2 and the following paragraphs.

Also shown by FIG. 2 is market module 109 that can store market data in exchange repository 110. Briefly, market module 109 can be configured to provide an online marketplace for the exchange of products. For example, market module 109 can generate one or more web-pages that can be sent to computing devices, e.g., computer systems, mobile phones, etc., that can be used to search for products, list products for exchange, and/or register for notifications for products. The lists of products for sale, offers for products, etc., can be stored in exchange repository 110, which can be effected by one or more databases.

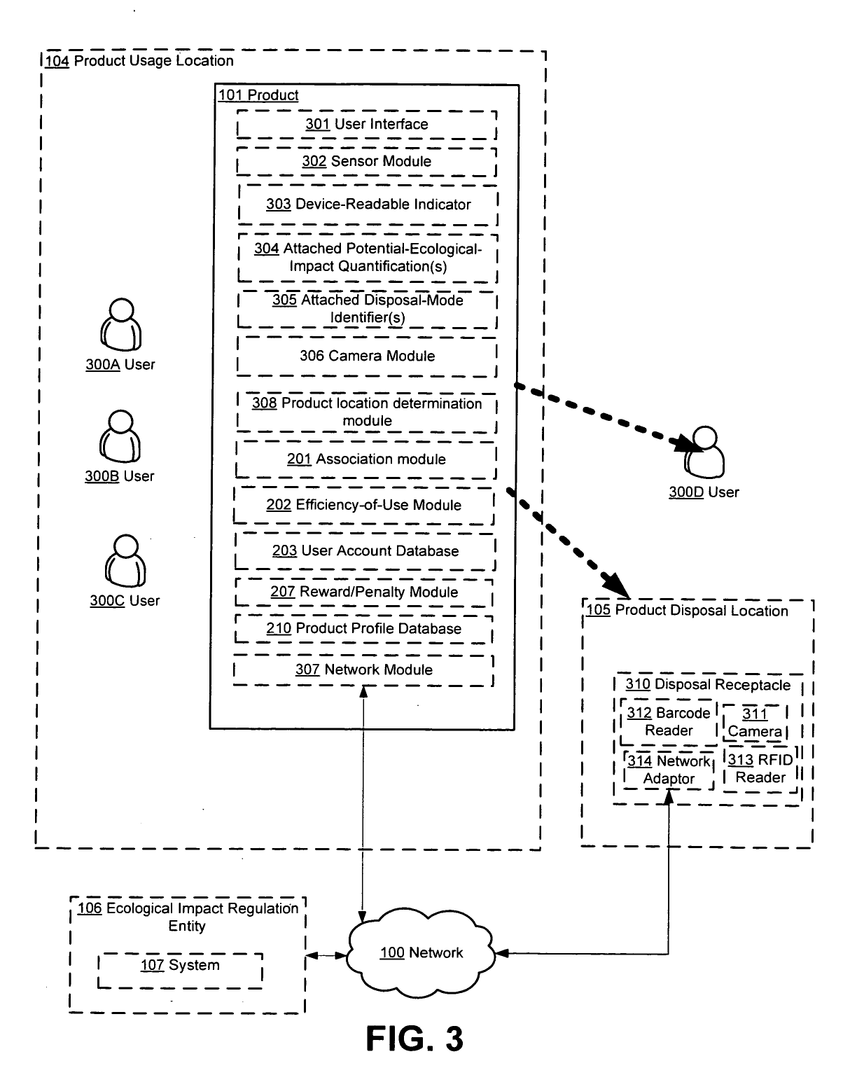

Continuing with the high-level overview of FIG. 1, system 107 can include social networking module 111 and/or email module 112. Briefly, social networking module 111 can be configured to generate one or more web-pages that can be sent to computing devices such as device 309 of FIG. 3, which is described in more detail below. In an exemplary embodiment, the web-pages can allow users to create and manage user profiles and/or interact with other users that have created profiles. In the same, or another exemplary embodiment, the web-pages can be used to interface with a lifecycle module 113, which is described in more detail below. The email module 112 may provide an email system that can send emails to computing devices such as device 309 of FIG. 3. In an exemplary embodiment, the emails can contain various information such as offers to purchase products, rewards, ecological impact quantifications (described in more detail in the following paragraphs), etc.

A media distribution center 114 is also illustrated in FIG. 1. The media distribution center 114 can be maintained by the same organization that maintains system 107 or a separate entity. Generally, media distribution center 114 can be configured to receive; store; and/or disseminate information gathered by system 107. For example, media distribution center 114 can be configured to include a web server hosting a social media database, email server, short message service (“SMS”) server, television station, etc. In a specific example, media distribution center 114 can receive, store, and/or disseminate information such as efficiency-of-use scores and/or ecological impact scores (which are described in more detail in other paragraphs) for users.

In the same, or other embodiments, system 107 which can include one or more computer systems having processors, memory, operating system software, network adaptors, etc., can be used to compute efficiency-of-use scores and/or ecological impact quantifications for users based on how they use products. For example, system 107 could be maintained by any number of individuals or organizations that wish to monitor how efficiently users use products. In a specific example, system 107 could be maintained by the ecological impact regulation entity 106 (e.g. a governmental entity) which regulates the ecological impact of product 101 according to established standards. In this exemplary embodiment, the government can monitor the ecological impact quantifications associated with the product 101 and take remedial measures with respect to one of more entities in the life-cycle of the product 101 in response thereto. Specifically, legislation and/or governmental regulations may dictate allowable levels of certain components having undesirable physiological effects on humans (e.g. lead) which may be incorporated into a product 101 or potentially detrimental effects on the environment (e.g. CFCs). As such, the system 107 maintained by the ecological impact regulation entity 106 may serve to monitor compliance of the product 101 with the legislation and/or governmental regulations through tracking of ecological impact quantifications associated with the product 101.

In another exemplary embodiment, system 107 can be controlled by a Green Organization, e.g., an entity that stands for reducing the impact humans have on the environment. In this example, enrollment with system 107 can be voluntary. In yet another exemplary embodiment, system 107 can be controlled by the owner of product 101, which could be a user or a company. In this case, the owner may require potential users of the product 101 to register with the system in order to use product 101. For example, if product is a rental car, system 107 could be controlled by the rental car company. In another specific example, system 107 could be controlled by a neighborhood or condominium association that has communal assets that can be used by various members of the association. In this case, each person that lives in the neighborhood or is a member of the condominium association may register with system 107 in order to use product 101. The system 107 may include a network module 115 configured to transceive signals between the ecological impact regulation entity 106 and one or more of the product manufacturer 102, product retailer 103, product usage location 104 and or product disposal facility 105 in order to obtain ecological impact and/or efficiency of use data associated with the product 101.

Referring now to FIG. 2, system 107 can also include association module 201, efficiency-of-use module 202 and user account database 203. The association module 201 can be a module of executable instructions that upon execution by a processor can cause the processor to link specific instances of a product 101 to a user account associated with a user of the product 101. Briefly, each instance of a product tracked by system 107 can be assigned a unique identifier, e.g., a device-readable indicator or a device-readable indicator plus a unique serial number, and each user that could potentially use the tracked products can be assigned a user account, which can be stored in user account database 203. When a user takes control of a product, e.g., when he or she possesses product, association module 201 can create a relationship between information that identifies the account of a user, e.g., user account 204, and the identifier for product 101. The user account 204 is illustrated, which can be associated with a user 300 (e.g. a product manufacturer 102, product retailer 103 and product disposal facility 105) described in more detail in the following paragraphs (while one user account is shown, user account database 203 of system 107 can maintain user accounts for a plurality of users). More specifically, a user 300 may be any entity within the life-cycle of the product 101 who may be subject to regulation by the ecological impact regulation entity 106.

The user account database 203 can be maintained by the entity that controls or uses system 107. For example, suppose system 107 is setup by a governmental agency. In this example, user account database 203 may include user accounts for users subject to ecological impact legislation and/or regulation by the ecological impact regulation entity 106. In another example, suppose system 107 is setup by an energy provider utility. In this example, user account database 203 may include user accounts for users that receive energy from the utility company.

Each user account 204, can optionally include a product list 205, which can contain a listing of products associated with user account 204, i.e., products manufactured and/or sold by the user. Each product in the list can be associated with information that describes its status, e.g., in production, inventory, sold, disposed of, etc., and/or a disposal method selected to dispose of the product, how long the product has been associated with the user account, a unique serial number for the product (which can be used to associate specific instances of a product with a specific user), etc.

In another embodiment, the user account 204 can be associated with one or more efficiency-of-use scores that reflect how efficiently the user 300 has used or is using a product 101 and/or ecological impact quantifications that reflect how much impact that use has on the environment. In an exemplary embodiment, these values can be stored in efficiency-of-use table 206 and ecological impact table 221, respectively.

In the same, or another embodiment, a cumulative ecological impact quantification for a user 300 can be generated and stored in ecological impact table 221. Briefly, the ecological impact quantification can be a combination of ecological impact quantifications for different products (e.g. a product line manufactured and/or sold by user 300). The ecological impact quantification can be a numerical value, e.g., a value from 0 to 10, −100 to 100, etc. In a specific example, higher efficiency-of-use scores could reflect more ecological impact. Thus, a score of 0 in a specific embodiment where the score runs from 0 to 10 would reflect an extremely low ecological impact whereas a score of 10 would reflect an incredibly high ecological impact. In other exemplary embodiments, the efficiency-of-use score could be an abstract indicator such as “bad” or “good.”

As described in more detail in the following paragraphs, one or more ecological impact quantifications can be calculated and used in a variety of ways. For example, in a specific exemplary embodiment, reward/penalty module 207 can be configured to reward or penalize the user 300 based on ecological impact quantifications associated with product 101. After a user 300 finishes manufacturing a product 101 or after the user 300 has sold the product 101, an ecological impact quantification can be computed and routed to reward/penalty module 207. The reward/penalty module 207 can process the product 101 and determine whether to reward (e.g. provide an account credit) or penalize (e.g. assess a fine) the user based on the ecological impact quantification. If the user is penalized or rewarded, information can be stored in reward/penalty module 207. For example, a reward stored in reward/penalty information table 208 could include an icon indicative of a trophy created by an organization committed to acting in an environmentally friendly way. In another embodiment, reward/penalty information table 208 could include a graphic indicative of a coupon, a gift certificate, information indicating free or reduced services given to user 300, etc. Similarly, reward/penalty information table 208 can include penalties associated with user account 204 based on product use behavior. For example, a penalty could be a fee charged to user 300, a trophy with a negative association, etc. In another specific example, ecological impact quantification can be used to charge users based on failure to comply with applicable ecological legislation and/or regulations. For example, accounting module 209 can be configured to assess fines against a user account 204 based on ecological impact quantifications associated with the user account 204.

Continuing with the brief overview of certain elements depicted within FIG. 2, efficiency-of-use module 202 can be used to compute efficiency-of-use scores. For example, efficiency-of-use module 202 in embodiments of the present disclosure can be configured to use efficiency information for one or more categories of data to compute an efficiency-of-use score that reflects how efficiently the user is using the product. In a simple example, a product could be a light bulb and efficiency information could be gathered that describes how much energy it uses over a time period, e.g., a day. In this example, the category of data for the light bulb is energy consumed per day. A more complex example may be for an automobile. In this example, data from multiple categories may be used to compute an efficiency-of-use score, e.g., miles per gallon of gasoline achieved data, number of passengers riding in the automobile, miles driven, brake force applied, etc.

In a specific example, each category of data used to compute a score can be associated with a use profile, which can be stored in product profile database 210. Each profile can indicate a standard that reflects efficient use for a category of data. For example, the light bulb referred to above could be associated with a use profile that defines an efficient amount of energy that a light bulb should use over a 24 hour period. In this example, the amount of energy actually used and the amount of energy that defines efficient use can be used to compute the efficiency-of-use score.

As shown in FIG. 2, product profile database 210 can be associated with tables of information, which can be used in exemplary embodiments of the present disclosure to configure efficiency-of-use module 202. Briefly, image table 211 can include images of products that can be associated with device-readable indicators. In an exemplary embodiment, a product 101 may not include device-readable indicator 303 (as described below) and efficiency-of-use module 202 can determine an identity of the product 101 from images.

Further, as shown by FIG. 2, database 108 of system 107 can include a product information database 212, For example, each product 101 can be assigned a device-readable indicator which can include information for one or more products which could be a unique alphanumeric value that can be used to identify the product within system 107. Each user account 204 can also be assigned an alphanumeric value that can be used to identify the user account within system 107. The product information database 212 can store product information for a product 101 along with information for other products. As one of skill in the art can appreciate, the information described as “within” product information database 212 can be stored in one or more physical databases in one more geographic locations and the disclosure is not limited to the illustrated configuration.

The product information database 212 can include one or more collections of information gathered by an agent of ecological impact regulation entity 106 and/or by an agent of product manufacturer 102. In embodiments of the present disclosure, the collected data can be used to generate ecological impact quantifications, e.g., values such as 5 impact points or abstract values such as “good,” “average,” or “bad,” for at least one stage of a product's lifecycle, e.g., its production phase, use phase, and/or disposal phase, that can be stored in product information database 212 in the appropriate section (namely, production phase quantification table 217, use phase quantification table 218, and/or disposal phase quantification table 219, the latter potentially including multiple quantifications for a product: one quantification for each disposal mode for a product.)

One type of data can be gathered and stored in rare materials table 213 is an itemized list of the materials that are used up and/or the materials that that a product 101 is made from when it is manufactured. In at least one exemplary embodiment, data that identifies the rare materials that are in product 101 (and other products) and/or the rare materials that were consumed in the process of making product 101 can be used to generate one or more ecological impact quantifications. For example, an agent from ecological impact regulation entity 106 and/or product manufacturer 102 can obtain a breakdown of the components in product 101 and derive the amount of rare-earth materials and/or rare materials that were used to create product 101.

Rare materials can include rare-earth materials and/or materials that are simply scarce. For example, the International Union of Pure and Applied Chemistry has established a collection of chemical elements from the periodic table that are considered “rare-earths.” For the most part, these elements are not rare in the sense that they are not abundant, but that they are difficult to purify from their oxides. Rare-earth elements are essential components in modern electronics and demand is growing. For example, Cerium oxide, the lowest value rare earth, jumped 930 percent from 2007 to over $35 per kilogram in 2010. The rare-earth elements are Lanthanum (which can be used to create high refractive index glass, camera lenses, battery-electrodes), Cerium, Praseodymium, Neodymium, Promethium (which can be used to create nuclear batteries), Samarium, Europium, Gadolinium (which can be used to create computer memory), Terbium, Dysprosium, Holmium, Erbium (which can be used to produce vanadium steel), Thulium, Ytterbium, Lutetium, Actinium, Thorium, Protactinium, Uranium, Neptunium, Plutonium, Americium, Curium, Berkelium, Californium, Einsteinium, Fermium, Mendelevium, Nobelium, and Lawrencium.

Hazardous materials information for each product can be collected and stored in product information database 212 in, for example, hazardous materials table 214 and used to create one or more ecological impact quantification for products such as product 101. Hazardous waste can include waste that poses a substantial or potential threat to public health and/or the environment. The list of hazardous substances tracked and stored in hazardous materials table 214 may vary a bit from one country to another and can include, but is not limited to, substances that may explode when exposed to a flame or when shocked, substances that are highly flammable, etc., and/or substances that are toxic, corrosive, infectious, carcinogenic, etc.

Ground pollutant data can be stored in ground pollutant table 215 and used to create one or more ecological impact quantifications. Generally, ground pollutant data can include information such as the estimated amount of pollutants that are emitted by product manufacturer 104 (other than hazardous waste) when producing a product and/or the estimated amount of ground pollution generated by disposing of a product according to different disposal modes. In an exemplary embodiment, the ground pollutants tracked can include, but are not limited to, heavy metals, chlorinated hydrocarbons, led, zinc, benzene, etc. This type of typically enters the environment via landfills.

Carbon dioxide equivalent table 216 can include information about the greenhouse gases (i.e., normalized greenhouse gases expressed as carbon dioxide equivalent or CO₂e) that are associated with product 101. Greenhouse gasses are emitted in almost every stage of a product's lifecycle and in an exemplary embodiment, the amount of normalized greenhouse gasses that can be attributed to the production, use, and/or disposal of a product can be collected and used to generate one or more ecological impact quantifications. For example, an agent from ecological impact regulation entity 106 or product manufacturer 102 can measure the amount of electricity used by product manufacturer 102 and determine how much energy is used to manufacturer one product. The source of the energy can be determined from the power plant and the amount of CO₂e emissions generated by the power plant in order to produce the power used to acquire raw materials and manufacture a product can be captured and stored in CO₂e table 216.

The amount of CO₂e generated from power plants can be estimated from information obtained from the energy grid. For example, the power company that manages the grid can provide information that identifies the source of the energy, e.g., hydro-power, natural gas, coal, etc., and the CO₂e emissions with each energy source can be calculated as well as the percentage of energy generated from each source. In this example, the amount of CO₂e emissions that can be tied to the production of the energy needed to create product 101 can be captured and stored in CO₂e table 216.

The list of gasses can include the following and an amount of each gas can be multiplied by a scalar value, shown in parenthesis, in order to convert the gases (in metric tons) to CO₂e: carbon dioxide (1), methane (21), nitrous oxide (310), perfluorocarbons (2,300), hydrofluorocarbons (12,000), and sulfur hexafluoride (23,900). This shows that one million metric tons of methane and nitrous oxide is equivalent to emissions of 21 and 310 million metric tons of carbon dioxide. In an exemplary embodiment, information provided from the Environment Protection Agency (the “EPA”) can be used to estimate the amount of CO₂e associated with products. This information can be found in the report entitled “Inventory of U.S. Greenhouse Gas Emissions and Sinks: 1990-2005” and the EPA's report entitled “Solid Waste Management and Greenhouse Gases: A lifecycle Assessment of Emissions and Sinks,” 3^{rd} Edition September 2006, both of which are herein incorporated in their entirety.

In exemplary embodiments, some or all of the above mentioned data can be used to generate one or more ecological impact quantifications for one or more products. For example, an exemplary ecological impact quantification could be based at least in part on the amount of rare-materials associated with a product, the amount of hazardous waste associated the product, the amount of ground pollution associated with the product, and/or the amount of CO₂e associated with the product. For example, 60 kilograms of CO₂e may be emitted during the manufacturing process for a cellular phone. In an exemplary embodiment, this amount of CO₂e can be quantized along with the amount of rare materials in the cellular phone, the amount of hazardous waste and ground pollution created to make the cellular phone. The quantifications can then be combined, e.g., added, multiplied, etc., in order to create an ecological impact quantification.

Each ecological impact quantification can be categorized into groups for different stages of a product's lifecycle. For example, ecological impact associated with a production phase can be stored in production phase quantification table 217. The other tables being use phase quantification table 218, and disposal phase quantification table 219. In an exemplary embodiment, a single product may be associated with an ecological impact quantification that is based on the potential harm to the environment caused by producing the product, an ecological impact quantification that is based on the potential harm caused by using the product, and ecological impact quantifications for the potential harm that could be caused by the different ways of disposing of the product. In another exemplary embodiment, a single ecological impact quantification can be generated that shows the cumulative ecological impact caused by the product, e.g., the ecological impact quantification could be the sum of all of the aforementioned ecological impact quantifications for the different phases of the product's lifecycle.

In a specific example, production ecological impact quantifications can be based on the amount of rare-materials in a product or the amount of rare-materials that were consumed to create a product. In this example, the quantification process can use the price of the rare-material and/or the amount of the rare-material in product 101 when generating an ecological impact quantification. For example, a kilogram of a less valuable rare-earth material such as cerium oxide could be mapped to a materials-score of 1 where as a kilogram of praseodymium (a more expensive rare-earth) can be mapped to an ecological impact quantification of 9. The materials ecological impact quantification can optionally be combined with other ecological impact quantifications to create a production ecological impact quantification.

In addition to rare-materials, a production ecological impact quantification can be based on the amount and type of hazardous waste that was created to produce a product. For example, a high amount of a dangerous type of hazardous waste can be mapped to a high ecological impact quantification. This ecological impact quantification can optionally be combined with other ecological impact quantifications to create production ecological impact quantification.

In yet another embodiment, a production ecological impact quantification can be based on the amount of CO₂e generated to create a product 101. For example, CO₂e is typically emitted during this phase in order to generate the energy to transport raw/manufactured materials to product manufacturer 102 and the energy needed to assemble the materials into the product 101. In this example, the amount of CO₂e generated to build one product can be estimated and mapped to a CO₂e-based ecological impact quantification. For example, low amounts of CO₂e can be mapped to low CO₂e-based ecological impact quantifications and high amounts of CO₂e can be mapped to high CO₂e-based ecological impact quantifications. A CO₂e-based ecological impact quantification can then be combined with one or more other ecological impact quantifications to obtain a production phase ecological impact quantifications.

CO₂e emissions associated with acquiring raw materials and manufacturing product 101 can include energy consumed to obtain raw materials, manufacturer products, manage the corporation, and dispose of waste. In general, the majority of energy used for these activities is derived from fossil fuels burned to operate mining equipment, fuel blast furnaces, etc., and to generate electricity to power machines used during the manufacturing stage.

Use phase ecological impact quantifications can reflect the potential harm caused to the environment due to the transporting, storing, and actually using a product. The majority of the ecological impact in this phase can be attributed to CO₂e emissions associated with the power used by a product, and/or the CO₂e emitted by product as it operates, e.g., a vehicle. Food services products may require refrigeration, which requires electricity that is associated with CO₂e emissions. Most cold storage facilities operate at a wide range of temperatures. In an exemplary embodiment, an average temperature can be estimated along with an average size of a storage facility and the average amount of energy used to refrigerate a product, which may be a six pack of beer. This information along with the volume of the product can be used to estimate the CO₂e emissions caused by storing the product in a refrigerated facility. The CO₂e emissions can be used to generate a use phase ecological impact quantification, which can be stored in use phase quantification table 218.

Similar to the aforementioned ecological impact quantification associated with transportation and/or storage, an ecological impact quantification associated with operating the product can be calculated from mostly the CO₂e emitted in order to generate the power for a product and/or the CO₂e emitted by the product as it is running. This data can be gathered for product 101; stored in CO₂e table 216; and used to generate a CO₂e based use phase ecological impact quantification. For example, any product that consumes electricity most likely causes harm (even if it is indirect harm) to the environment due to the fact that the power it consumes likely comes from a source of energy that generates CO₂e.

When a user is finished with a product (when it is at the end of its life for example) it can be disposed of. In an exemplary embodiment, disposal phase ecological impact quantifications can be based on one or more of the amount of rare materials lost due to disposing of a product, the amount of CO₂e emitted when disposing of a product (either from the product or from the equipment used to dispose of the product), the amount of hazardous waste that product emits during disposal, the amount of ground pollution generated by disposing of a product, etc. In an exemplary embodiment, each disposal phase ecological impact quantification can be associated with a disposal-mode-identifier stored in disposal-mode-identifier table 220. The disposal-mode-identifier can be associated with information that describes how to dispose of the product according to a disposal mode. For example, a recycling disposal-mode-identifier could be associated with text that provides the address of a recycling facility or a map to the recycling facility. In another specific example, an incineration disposal-mode identifier can include audio describing which type of disposal receptacle, e.g., trash can, dumpster, etc., the product should be placed in to have it incinerated.

Since a product can be disposed of in different ways, each product can be associated with multiple disposal ecological impact quantifications. An exemplary, non-exhaustive list of disposal modes can include reselling (and/or donating, trading, etc), recycling, composting, incinerating, landfilling, etc. Thus, in an exemplary embodiment a product can be associated with one or more ecological impact quantification for each disposal mode that is available to a product. For example, a product such as an mp3 player may have available modes that include a reselling mode, a recycling mode, and a landfilling mode.

In an exemplary embodiment, a product can be associated with a resell disposal mode. In this exemplary embodiment, the ecological impact quantification associated with reselling the product can be based on an estimated amount of CO₂e used to transport the product from one user to the next user. In some instances, the CO₂e may be negligible.

In an exemplary embodiment, a product can be associated with an ecological impact quantification associated with a recycling disposal mode. In an exemplary embodiment, the ecological impact quantification for recycling can be based on, for example, the amount of CO₂e associated with generating the power used to disassemble the product, the amount of rare materials that are lost during the recycling process, etc. Since recycling a product involves disassembling the product and using parts of it in other products, products made from a recycled product may have lower production phase ecological impact quantifications than similar products made from virgin materials.

Composting is another disposal mode and an ecological impact quantification for composting a product can be generated. Composting is the process of disposing of organic material by way of aerobic decomposition. For example, composing may result in CH₄ emissions from anaerobic decomposition and N₂0 may be released by the soil after compost is applied to the ground, however these emissions are essentially zero. Composing has an additional benefit of capturing carbon and can be used to enrich soils. Disposal by sequestration is another technique used to reduce the amount of carbon that escapes into the environment. The EPA estimates composting/sequestering reduces the amount of CO₂e emitted by 0.05 metric tons of CO₂e per ton of compost. In an exemplary embodiment, the information can be used to generate a composing CO₂e-based ecological impact quantification for products that can be composted. In some instances, this ecological impact quantification could reduce the harm caused to the planet.

Another disposal mode is incineration. Incineration involves the combustion of organic substances within waste materials thereby converting the waste into ash, heat, and flue gases, which may contain significant amounts of particulate matter, heavy metals, dioxins, furans, sulfur dioxide, and hydrochloric acid, and/or CO₂. Municipal solid waste (“MSW”) contains approximately the same mass fraction of carbon as CO₂ itself (27%), so incineration of 1 ton of MSW produces approximately 1 ton of CO₂. In an exemplary embodiment, the amount of CO₂e emitted by incineration, the amount of CO₂e generated in order to power the incineration facility, the amount of hazardous waste generated, etc., can be gathered; and used to create a ecological impact quantification for disposing of a product according to an incineration mode of disposal. Similar to incineration, waste can evaporated by storing liquids in evapo-transpiration beds or mechanical evaporation units and ecological impact quantifications can be developed that reflect the harm to the environment caused by evaporating liquid products.

A disposal mode for a product could include sending the product to a landfill. During solid-waste landfill operations, waste collection vehicles transport the waste materials to a tipping face or working front where they unload their load. After loads are deposited, compactors or dozers can be used to spread and compact the waste on the working face and the compacted waste can be covered with soil daily.

Landfills cause a number of problems for the environment such as pollution by the contamination of groundwater and soil and the gasses released by decaying organic material. The CO₂e emissions of a landfill are mostly due to methane emissions, transportation related carbon dioxide emissions, and carbon storage resulting from landfilling organic waste and solid waste. Metals do not contain carbon and do not generate CO₂e emissions, however they could cause ground pollution. For example, salt, nitrates, led, copper, nickel, cadmium, etc., are different materials that can cause ground pollution. Plastics do not biodegrade and therefore do not emit greenhouse gases. This information can then be used to create a landfill ecological impact quantification.

Ocean floor disposal is another disposal method. This technique involves depositing waste, e.g., radioactive waste, in ocean floor sediment. Exemplary techniques for depositing waste involve encasing the waste in concrete or in a shaft drilled into the bottom of the ocean. Ecological impact quantifications can be created that take into account the ecological harm caused by depositing waste in the ocean.

In another embodiment, ecological impact quantifications may be one factor used to calculate an ecological impact score. In this specific example, the ecological impact score can be adjusted by the amount of environmentally friendly activities the user undertakes, e.g., by purchasing carbon credits or performing other activities that have a positive effect on the environment. In another exemplary embodiment, the ecological impact score can be adjusted based on how a user uses a product. For example, a user that purchases a car and drives it once a month is not efficiently using the vehicle and a better decision would have been for the user to take public transportation or join a car-sharing group such as Zipcar®. In this specific example, information that describes how intensely the product has been used could negatively/positively affect the user's ecological impact score. In another exemplary embodiment, the ecological impact score can be adjusted based on a group the user is a member of. For example, a user could be part of a “Green” group that sets requirements for how long products should be used before disposal. In this example, the user's compliance/noncompliance rate can affect his or her ecological impact score.

Each user account 204 may include one or more ecological impact quantification values maintained in ecological impact table 221, which can be based in part on an estimated impact on the environment associated with use of a product 101 by a user 300. In a specific example embodiment, an ecological impact score can be a running score of the ecological impact quantifications associated with ownership and use of a product 101 by a user 300. For example, suppose a user has an estimated impact score of zero points and purchases a product 101 (e.g. a mobile phone) with an ecological impact quantification due to manufacturing the mobile phone of 4 impact points. The user uses the product 101 for three years and accumulates 5 impact points from charging the product 101 over the years. After the three years user may throw the product 101 out in a landfill and cause 3 impact points. The total ecological impact for the product 101 could be 12 impact points. In this specific example, the ecological impact table 221 associated with use of the product 101 by the user 300 could be 12 impact points.

Further, a user account 204 can be tied into a social network where users can blog, post pictures, send message to each other, etc. A social networking module 111 can be configured to generate one or more web-pages that can be downloaded to computing devices, e.g., table personal-computers, smart phones, etc., that include logic operable to allow users to interact with each other. For example, social networking module 111 may include a web-server module 222. The web-server module 222 can be configured to generate one or more web-pages that can be downloaded to computing devices, e.g., desktop personal-computers, smart phones, etc., that include logic operable to allow users to interact with each (blog, post pictures, personal status updates, etc).

Continuing with the description of FIG. 2, reward/penalty information table 208 can include data indicative of the reward/penalty a user 300 has earned due to his or her product purchasing and/or disposal behavior. For example, a reward stored in reward/penalty information table 208 could include an icon indicative of a trophy created by an organization committed to acting in an environmentally friendly way. In another embodiment, reward/penalty information table 208 could include a graphic indicative of a coupon, a gift certificate, information indicating free or reduced services given to user 300, etc. Similarly, reward/penalty information table 208 can include penalties associated with user account 204 based on disposal and/or product purchasing behavior. For example, a penalty could be a fee charged to user 300, a trophy with a negative association, etc.

Turning back to user account 204, a user account can have a friends list 223, which links user account 204 to other user accounts. Also shown is ecological statistics table 224, which can include information such as the number of times a user has selected an incineration mode of disposal vs. recycling or reselling mode of disposal, how user 300 compares to other users on his or her friends list, etc.

The system 107 is also shown as including lifecycle module 113. The lifecycle module 113 can be configured to generate an ecological impact score for a user account, determine whether to display disposal mode indicators, (which are described in more detail in the following paragraphs), and/or search for various information within database 108, etc.

In an exemplary embodiment, the lifecycle module 113 can be associated with tables of information, which can be used in exemplary embodiments of the present disclosure to configure lifecycle module 113. Briefly, the tables can include, but are not limited to, threshold table 225 and/or a quantification adjustment table 226. The threshold table 225 may include threshold data associated with various computations executed by the lifecycle module 113. For example, threshold table 225 may include threshold data associated with: quantities of raw materials used to manufacture product 101; CO₂e values associated with various phases of the lifecycle of the product 101; and other characteristics of the product 101. The quantification adjustment table 226 can include adjustment-quantifications that can be used to adjust ecological impact scores based on certain criteria that will be described in more detail in the following paragraphs.

A group profile database 227 can be used to store information about one or more groups of users 300 such as group profile 228, of which user 300 may be a member in an exemplary embodiment. A group profile 228 can store information such as a group policy, which includes various criteria that can be used to adjust ecological impact scores, reward users, etc. For example, a group policy can include a disposal timetable for a product or a type of product. The timetable can be used to determine whether a user has owned a product for an acceptable length of time before disposing of it according to disposal mode that causes harm to the environment. In a specific example, product 101 is an mp3 player, and group profile 228 includes a list of acceptable disposal modes for the mp3 player, each of which is associated with a time-value. Also suppose that a user wants to dispose of the mp3 player by sending it to a landfill. In this example, a time-value for landfilling the mp3 player is 5 years. In this example, suppose a landfill disposal mode was selected for the mp3 player in year 3 of its existence. In this example, lifecycle module 113 can calculate the amount of time the mp3 player has existed and compare it to the time-value. In this example, lifecycle module 113 can determine that the mp3 player has been owned less than the time-value and generate an adjustment-quantification. For example, the adjustment-quantification could be 2, which indicates that the mp3 player is being disposed of 2 years early. The lifecycle module 113 can combine the adjustment-quantification with the ecological impact quantification for disposing of the mp3 player via a landfill and add the result to ecological impact score.

FIG. 3 generally illustrates an exemplary environment, which could be product usage location 104, e.g., a home, a company, a city, etc. wherein a product 101 is used by a user 300. As shown in FIG. 3, product 101 can be used by users (e.g. user 300A, user 300B, user 300C) during its life. For example, product 101 could be a product that is used by multiple people, e.g., a rental car, a communal washing machine, etc. In this example, user 300A may use product 101 once (or for a short period of time) and then user 300B may use product and so on and so forth. The use of product 101 by each user 300 in this example can be monitored, for example by ecological impact regulation entity 106 who could be an agent of the owner of product 101, e.g., an employee of a rental car company, an employee of a laundromat, etc.

In another embodiment, product 101 may be owned by a user, such as user 300A and used by user 300B and/or user 300C. For example, product 101 could be owned by a head of a household (e.g. user 300A) and used by other members of the family (e.g. user 300B and/or user 300C). In another instance, product 101 could be owned by a corporation and used by employees of the company.

As shown by the FIG. 3, product 101 itself may include the association module 201, efficiency-of-use module 202, product profile database 210, reward/penalty module 207 of system 107, which may operate as described above with respect to the ecological impact regulation entity 106. Thus, in certain embodiments of the present disclosure, efficiency-of-use scores and/or ecological impact quantifications may be computed by the product itself using one or more use profiles that could be locally stored or stored by system 107. Accordingly, while certain operations are described herein as being executed by system 107 in specific examples, the disclosure is not limited and each one of the operations described with respect to association module 201, efficiency-of-use module 202, and product profile database 210 could be executed on product 101.

As shown by FIG. 3, the product 101 may further include user interface 301, sensor module 302, device-readable indicator 303, an attached ecological impact quantification 304, an attached disposal-mode identifier 305, camera module 306, network module 307 and/or product location determination module 308 (e.g. a global positioning system (GPS) module). Briefly, user interface 301 can be any type of user interface such as a touch screen or a display and an input device, e.g., a mouse, touch pad, microphone, a keypad, a keyboard, etc. The sensor module 302, which is described in more detail below, can be the hardware and/or software operable to measure a physical quantity associated with the product 101 and convert it into an electrical signal. The product 101 can optionally include device-readable indicator 303, which can be information that can be extracted by a device 309 in order to obtain information about the product 101. The device-readable indicator 303 could be an alphanumeric value, which can be stored in memory, e.g., RAM or ROM, in a barcode, in an RFID tag, or physically written on or etched into product 101. In an exemplary embodiment, device-readable indicator 303 can be associated with a unique serial number that also identifies the specific instance of product 101.

In an exemplary embodiment, an ecological impact quantification can be attached to product 101 in attached ecological impact quantification 304. In this example, a device 309 or the ecological impact regulation entity 106 may be able to obtain one or more ecological impact quantification 304 from product 101. Similar to the aforementioned device-readable indicator 303, attached ecological impact quantification 304 can be stored in memory, a barcode, an RFID tag, and/or etched onto product 101.

In yet another embodiment, product 101 may have at least one attached disposal-mode identifier 305. The disposal-mode identifier 305 can include instructions, e.g., text, audio, images, for disposing of product according to a disposal mode, e.g., incineration, recycling, landfilling, etc.

FIG. 3 further illustrates an exemplary environment, which could be product disposal facility 105. The large dashed arrow indicates that product 101 could be optionally disposed of by placing product 101 in disposal receptacle 310, e.g., a recycling bin or trash, or given to another user such as user 300D. The disposal receptacle 310 may be any receptacle associated with the product disposal facility 105 which may receive a product 101. For example, the disposal receptacle 310 may be a garbage can, a garbage truck, a recycling kiosk, and the like.

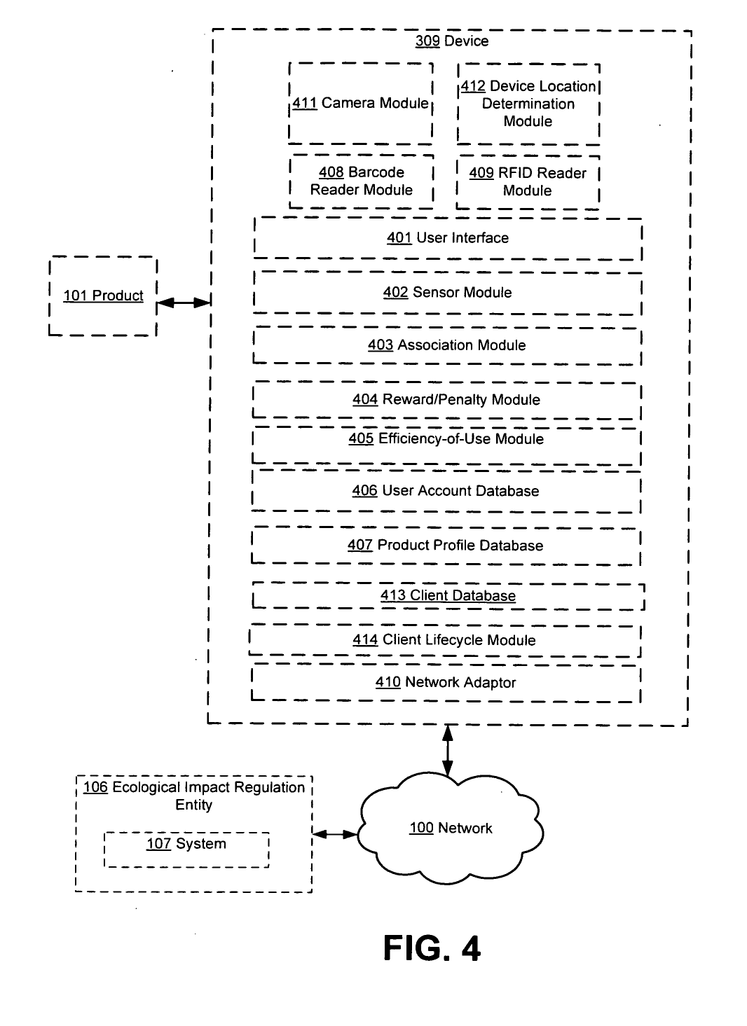

Referring to FIG. 4, it illustrates exemplary modules that can be integrated within device 309. The device 309 may be a computing/communication device including, for example, a cellular phone, a personal digital assistant (PDA), a laptop, a desktop, or other type of computing/communication device. In an exemplary embodiment, device 309 may be a handheld device such as a cellular telephone, a smart phone, a Mobile Internet Device (MID), an Ultra Mobile Personal Computer (UMPC), a convergent device such as a personal digital assistant (PDA), and so forth. For example, device can include memory, e.g., random access memory, ROM, etc., that can contain executable instructions that can be executed by a processor. In addition, device 309 can include various integrated circuits such as GPS radios, network interface adaptors, etc., and the associated firmware that operates such devices. The device 309 can include user interface 401, which could include, but is not limited to, input components implemented by a combination of hardware and software such as a touch user interface, a keypad, a directional pad, a microphone, etc., and output components such as a screen, e.g., an liquid crystal display, a speaker, etc.

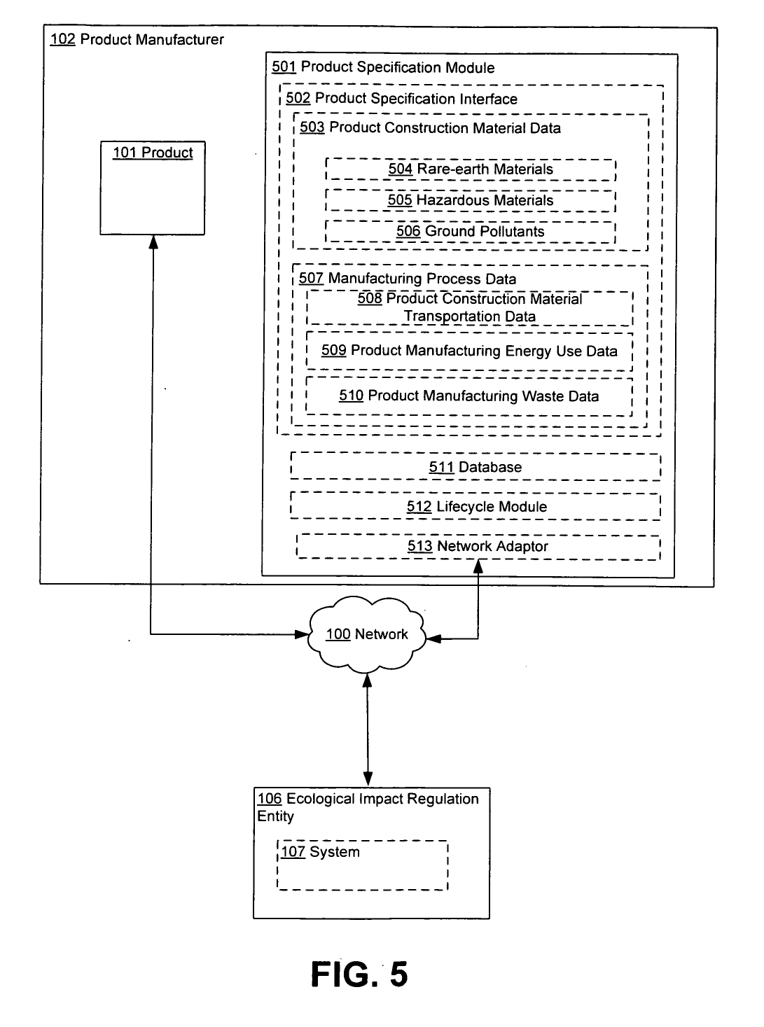

The device 309 can further include sensor module 402, association module 403, reward/penalty module 404, efficiency-of-use module 405, user account database 406 and product profile database 407 that may operate similar to association module 201, efficiency-of-use module 202, reward/penalty module 207, user account database 203, and product profile database 210 as described above with respect to system 107 and/or product 101. Consequently, in embodiments of the present disclosure, the functionality described as being associated with association module 201, efficiency-of-use module 202, reward/penalty module 207, and product profile database 210 could be integrated within device 309. Thus, in certain embodiments of the present disclosure, efficiency-of-use scores may be computed by a device external to product 101 (e.g. device 309) using one or more use profiles that could be locally stored or stored by system 107. Accordingly, while certain operations described with respect to FIGS. 5-18 are described as being executed by system 107 in specific examples, the disclosure is not limited and each one of the operations described with respect to association module 201, efficiency-of-use module 202, reward/penalty module 207, and product profile database 210 could be executed on device 309.

The device 309 can obtain device-readable indicator 303 of the product 101 by communicating with product 101 and/or extracting it from product 101 using a barcode reader 408, RFID reader module 409, network adapter 410, or camera 411. In other exemplary embodiments, product 101 may not have an attached device-readable indicator 303, instead device-readable indicator 303 can be looked up from an image of product 101, audio of a user speaking about product 101, or from user input received by user interface 401. The device 309 can obtain device location information using device location determination module 412 (e.g. a GPS module).

A user 300 can optionally use device 309 to obtain ecological information about product 101 such as ecological impact quantifications. For example, product 101 can include memory, e.g., a barcode, random access memory, read-only memory, etc., which can be used to store information that can be used by device 309 to obtain information based off ecological impact quantifications and/or the ecological impact quantifications themselves, among other things.

As shown by the figure, product 101 can optionally include device-readable indicator 303, which can be information that can be extracted by device 309 in order to identify product 101. The device-readable indicator 303 could be an alphanumeric value, which can be stored in memory, e.g., RAM or ROM, in a barcode, in an RFID tag, or etched into product 101. In an exemplary embodiment, device-readable indicator 303 can be stored with a unique serial number that also identifies the specific instance of product 101. The device 309 can obtain device-readable indicator 303 by communicating with product 101 and/or extracting it from product 101 using a barcode reader 408, RFID reader module 409, network adapter 410, or camera 411. In other exemplary embodiments, product 101 may not have an attached device-readable indicator, instead device-readable indicator 303 can be looked up from an image of product 101, audio of a user speaking about product 101, or from user input.

In an exemplary embodiment, an ecological impact quantification can be attached to product 101 in attached ecological impact quantification 304. In this example, device 309 may be able to obtain one or more ecological impact quantifications from product 101 instead of from database 108 or client database 413. Similar to the aforementioned device-readable indicator 303, attached ecological impact quantification 304 can be stored in memory, a barcode, an RFID tag, and/or etched onto product 101. In an exemplary embodiment where product 101 does not include attached ecological impact quantifications, lifecycle module 113 or client lifecycle module 414 can be used to obtain device-readable indicator 303, which can be used to search database 108 or client database 413 for ecological impact quantifications, among other things.

In yet another embodiment, product 101 may have one or more attached disposal-mode identifier 305. Disposal mode identifiers can include instructions, e.g., text, audio, images, for disposing of product according to a disposal mode, e.g., incineration, recycling, landfilling, etc. Similar to the aforementioned device-readable indicators, a disposal mode identifier may not be attached to product 101. Instead, this information could be stored within database 108 and/or client database 413.

In an exemplary embodiment, user 300 can use device 309 to obtain ecological impact quantifications for product 101 so he or she can learn about the ecological impact associated with product 101. For example, suppose user 300 is interested in purchasing product 101, which could be a car, and may want to know the ecological impact the car had on the environment by being produced. In this specific example, user 300 may obtain the ecological impact the car had on the environment by using camera 411, e.g., a video camera and/or a still image camera, to take at least one picture of product 101. The one or more pictures can be processed by client lifecycle module 414 and/or lifecycle module 113 and device-readable indicator 303 can be obtained by client lifecycle module 414 and/or lifecycle module 113. For example, the image can be compared to other images stored in image table 211 and a match can be made.

Alternatively, an RFID (radio frequency identifier) tag can be attached to the car and device-readable indicator 303 can be stored therein. In this exemplary embodiment, device 309 can include RFID reader module 409, which can be configured to obtain device-readable indicator 303 from the car. The device-readable indicator 303 could then be used by client lifecycle module 414 and/or lifecycle module 113 to search a database such as database 108 and/or client database 413.

In another specific example embodiment, suppose a network adapter 410 is attached to the car. In this exemplary embodiment, device-readable indicator 303 can be stored in memory, e.g., RAM, ROM, etc. In this specific example, a point-to-point connection, e.g., via Bluetooth®, or a network connection, e.g., Wi-Fi, GSM, Wi-Max, etc., can be established between device 309 and product 101. The car can send information indicative of device-readable indicator 303 to device 309 within one or more packets of information via network adapter 410. The network adapter 410 of device 309, e.g., a Wi-Fi radio, can receive the packets and extract device-readable indicator 303. The device-readable indicator 303 could then be used by client lifecycle module 414 and/or lifecycle module 113 to search a database such as database 108 and/or client database 413.

Regardless of how device-readable indicator 303 is obtained, device 309 can use device-readable indicator 303 to obtain one or more ecological impact quantifications for the car in the instance that the car does not have attached ecological impact quantification 304. For example, suppose device 309 includes client lifecycle module 414, which can interact with lifecycle module 113 and does not include a client database in this specific example. Here, client lifecycle module 414 could request at least one ecological impact quantification associated with the production of the car from database 108 by sending device-readable indicator 303 to lifecycle module 113, which can use device-readable indicator 303 to search production phase quantification table 217 for an ecological impact quantification associated with producing the car. For example, lifecycle module 113 can receive a message which includes information such as a user account identifier for user account 204, device-readable indicator 303, and a value indicative of a request for a production ecological impact quantification for the product associated with device-readable indicator 303, i.e., the car. The lifecycle module 113 can receive the message and use device-readable indicator 303 to find a production ecological impact quantification for the car. The lifecycle module 113 can then send the ecological impact quantification to client lifecycle module 414 via network 100. In this example, client lifecycle module 414 can cause user interface 301 to render a bitmap in memory indicative of the ecological impact quantification. The user interface 301 can then render the bitmap to a display.

Turning back to FIG. 3, at the end of a product's life it can be disposed of. In an exemplary embodiment, user 300 may want to know how to dispose of product 101 and how disposing of product 101 may affect the environment. In this example, user 300 may use user interface 301 to indicate to device 309 that he or she would like to dispose of product 101. client lifecycle module 414 could receive user input and obtain device-readable indicator 303. The client database 413 and/or database 108 can be searched and a disposal-mode identifier 305 and/or a ecological impact quantification 304 can be found. The user interface 301 can then display a disposal-mode identifier 305 and/or a ecological impact quantification 304. In another specific example, client lifecycle module 414 could extract a disposal mode identifier from attached disposal-mode identifier 305 and/or an ecological impact quantification from attached ecological impact quantification 304 in response to user input indicative of a request to dispose of product 101.

The product 101 can then be disposed of by user 300 by placing product 101 within a disposal receptacle 310. In an exemplary embodiment, disposal receptacle 310 can detect product 101 (by extracting a device-readable indicator 303 from product 101 and/or or passively inferring the presence of product 101 within disposal receptacle 310, e.g., by taking a picture of product 101) via at least one of a camera 311, a barcode reader 312 and an RFID reader 313. The disposal receptacle 310 can use network adaptor 314 to send device-readable indicator 303 to client lifecycle module 414 or lifecycle module 113. The client database 413 and/or database 108 can be searched and a disposal-mode identifier 305 and/or a ecological impact quantification 304 can be found. The user interface 301 can then display a disposal-mode identifier 305 and/or a ecological impact quantification 304.

In another example, product 101 can be placed in disposal receptacle 310 and taken to product disposal facility 105. In this example, an agent of the product disposal facility 105 could extract device-readable indicator 303 and optionally the serial number of product 101 and send a message to lifecycle module 113 that includes the serial number, device-readable indicator 303, and the identity of product disposal facility 105. The lifecycle module 113 can use device-readable indicator 303 to find one or more disposal modes for product in disposal-mode-identifier table 220 and send the information back to product disposal facility 105. The agent can then select one of the disposal modes. The lifecycle module 113 can then use the serial number to identify a user account 204 that is associated with product 101 and update product list 205 to reflect that product 101 was disposed of according to the disposal mode selected by disposal facility.

Turning now to FIG. 5, FIG. 5 generally illustrates an exemplary environment, which could be product manufacturer 102 where a product 101 may be manufactured. As noted above, it may be desirable to determine the materials used in the construction of product 101 (e.g. rare earth elements, hazardous materials, etc.) as well various other ecological impact factors associated with the construction of the product 101 (e.g. energy use, waste, etc.) in order to characterize the complete ecological impact quantification of the manufacturing of the product 101 to allow for relative comparisons of the efficiency or non-efficiency of the associated manufacturing process.

It may be the case that, while a manufacturer of the product 101 may be aware of manufacturing specification data directly associated with the manufacturing process for product 101 (e.g. amount of materials used to construct the product, travel distances from vendor locations to the product manufacturer 102, manufacturing process parameters (e.g. process temperatures, pressures, residence times), etc.), the manufacturer may be unaware of the actual ecological impact of that manufacturing specification data. To that end, as shown in FIG. 5, a product specification module 501 may be provided at the product manufacturer 102. The product specification module 501 may be a software, hardware and/or firmware module configured to receive product specification data associated with the manufacturing of a product 101. Specifically, the product specification module 501 may be a client web application associated with a host server system maintained by the ecological impact regulation entity 106.

The product specification module 501 may further provide a product specification interface 502. The product specification interface 502 may present one or more data entry fields to a user allowing for the entry of product specification data associated with the manufacturing of a product 101. For example, the product specification interface 502 may be configured to receive product specification data such as product construction material data 503 (e.g. rare-earth material data 504, hazardous material data 505, ground pollutant data 506, etc.) and/or product manufacturing process data 507 (e.g. product construction material transportation data 508, product manufacturing energy use data 509, product manufacturing waste data 510).

The product specification module 501 may further include a database 511, lifecycle module 512 and network adapter 513 configured to provide functionality as described above with respect to database 108, lifecycle module 113 and network module 115 of system 107 of the ecological impact regulation entity 106. Such components may provide the functionality of remote system 107 at a location local to product manufacturer 102.

Following receipt of the product specification data by the product specification module 501, an ecological impact quantification may be computed from the product specification data. For example, the product specification module 501 may provide the product specification data associated with the manufacturing of a product 101 to at least one of the lifecycle module 512 associated with the product specification module 501 (i.e. local to the product manufacturer 102) and the lifecycle module 113 associated with the system 107 of the ecological impact regulation entity 106. The lifecycle module 512 associated with the product specification module 501 and/or the lifecycle module 113 of the ecological impact regulation entity 106 may access database 108 or database 511 respectively to obtain ecological impact quantification data associated product specification data associated with the manufacturing of a product 101.

For example, the product specification data may include data indicative of the mileage between a raw material supplier and the product manufacturer 102. The lifecycle module 113/lifecycle module 512 may obtain a CO₂e value associated with transporting a designated raw material the specified mileage from CO₂e table 216 of database 108/database 511 and correlate that CO₂e value to ecological impact quantification data maintained in production phase quantification table 217 to compute an ecological impact quantification associated with the mileage between a raw material supplier and the product manufacturer 102.

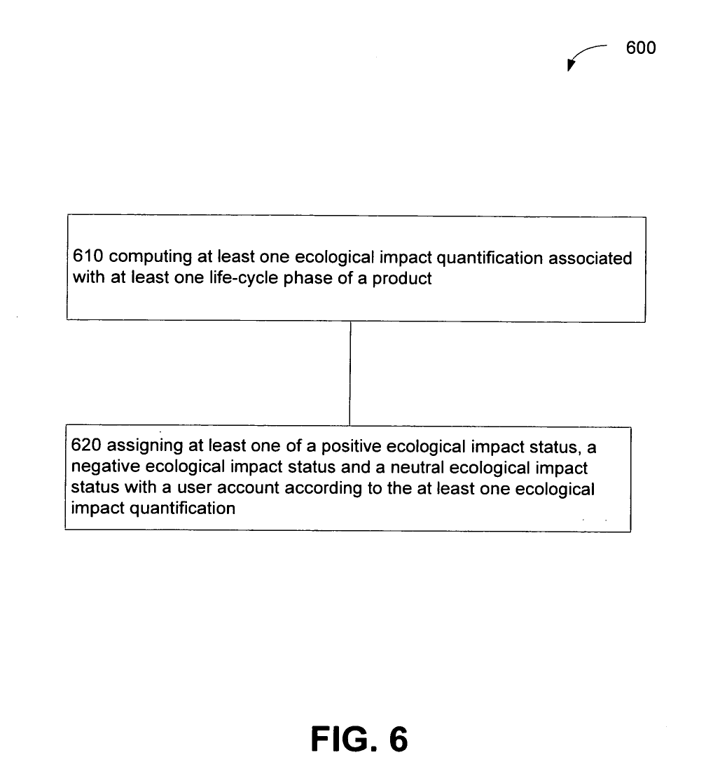

FIG. 6 and the following figures include various examples of operational flows, discussions and explanations may be provided with respect to the above-described exemplary environment of FIGS. 1-5. However, it should be understood that the operational flows may be executed in a number of other environments and contexts, and/or in modified versions of FIGS. 1-5. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

FIG. 6 illustrates an operational procedure 600 for practicing aspects of the present disclosure including operations 610 and 620.

Operation 610 shows computing at least one ecological impact quantification associated with at least one life-cycle phase of a product. As shown in FIG. 5, the product specification module 501 may receive product specification data (e.g. user inputs from designers, process engineers, business executives) defining one or more manufacturing characteristics associated with a product 101 (e.g. construction materials, materials transportation data, energy use associated with product manufacturing). The product specification module 501 may provide the product specification data to a lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with the product specification data for the product 101 from maintained in product information database 212 of database 108.

For example, the product specification data may include raw materials used in the manufacture of product 101. The lifecycle module 113 may query the hazardous materials table 214 of database 108 to determine if any of the raw materials are classified as hazardous materials. Upon a determination that one or more raw materials constitute the lifecycle module 113 may compare the amount of raw material classified as hazardous materials to a threshold amount of hazardous materials (e.g. a governmentally allowable amount of raw materials) maintained in threshold table 225. Should the amount of raw material classified as hazardous materials be below the threshold amount of hazardous materials, it may be indicative of a reduced ecological impact associated with the manufacturing of the product 101. Should the amount of raw material classified as hazardous materials be above the threshold amount of hazardous materials, it may be indicative of an increased ecological impact associated with the manufacturing of the product 101. The lifecycle module 113 may compute an ecological impact quantification according to the comparison between the amount of raw material classified as hazardous materials and the threshold amount of hazardous materials. For example, an amount of raw material classified as hazardous materials below the threshold amount of hazardous materials may be mapped to an ecological impact quantification of “1”, an amount of raw material classified as hazardous materials substantially equal to the threshold amount of hazardous materials may be mapped to an ecological impact quantification of “2” and an amount of raw material classified as hazardous materials above the threshold amount of hazardous materials may be mapped to an ecological impact quantification of “3.”

In an alternate example, the product specification data may include data associated with the transportation of quantity raw materials used in the manufacture of product 101. The lifecycle module 113 may query the CO₂e table 216 of database 108 to determine the CO₂e value associated with transporting an amount of raw material a given distance. Upon a determination of the CO₂e value associated with transporting an amount of raw material a given distance, lifecycle module 113 may compare the CO₂e value to a threshold CO₂e value maintained in threshold table 225. Should the CO₂e value associated with transporting an amount of raw material the given distance be below the threshold CO₂e value, it may be indicative of a reduced ecological impact associated with the manufacturing of the product 101. Should the CO₂e value associated with transporting the amount of raw material the given distance be above the threshold CO₂e value, it may be indicative of an increased ecological impact associated with the manufacturing of the product 101. The lifecycle module 113 may compute an ecological impact quantification according to the comparison between the CO₂e value associated with transporting the amount of raw material the given distance and the threshold CO₂e value. For example, a CO₂e value associated with transporting the amount of raw material the given distance below the threshold CO₂e value may be mapped to an ecological impact quantification of “1”, a CO₂e value associated with transporting the amount of raw material the given distance equal to the threshold CO₂e value may be mapped to an ecological impact quantification of “2” and a CO₂e value associated with transporting the amount of raw material the given distance above the threshold CO₂e value may be mapped to an ecological impact quantification of “3.”

Still further, the product specification module 501 may receive product specification data (e.g. user inputs from designers, process engineers, business executives) defining one or more manufacturing characteristics associated with a product 101 (e.g. construction materials). The product specification module 501 may provide the product specification data to an lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with disposal of at least a portion of the product according to a product disposal mode from the product information repository data maintained in database 108.

The product specification data may include raw materials used in the manufacture of product 101. The lifecycle module 113 may query the disposal phase quantification table 219 of database 108 to determine the various disposal mode options for disposing of the product based on the raw materials used in the manufacture of product 101 and assign an ecological impact quantification to one or more disposal modes according to the raw materials used in the manufacture of product 101.

For example, if a product 101 contains a high percentage of recyclable materials, the lifecycle module 113 may compute a relatively low ecological impact quantification for a disposal of the product 101 according to a recycling disposal mode. Alternatively, if a product 101 contains a low percentage of recyclable materials, the lifecycle module 113 may compute a relatively high ecological impact quantification for a disposal of the product 101 according to a recycling disposal mode.

As a further example, if a product 101 contains a high percentage of hazardous materials, the lifecycle module 113 may compute a relatively high ecological impact quantification for a disposal of the product 101 according to a landfill disposal mode. Alternatively, if a product 101 contains a high percentage of hazardous materials, the lifecycle module 113 may compute a relatively low ecological impact quantification for a disposal of the product 101 according to an incineration disposal mode.

Following computation of ecological impact quantifications associated with various product specification data types, those individual ecological impact quantifications may be aggregated (e.g. summed, averaged, weighted average) to provide an overall ecological impact quantification for the manufacture of the product 101. The ecological impact quantification for the product 101 (e.g. manufacturing and/or disposal ecological impact quantifications) may be stored to a user account 204 associated with the user 300.

Operation 620 shows assigning at least one of a positive ecological impact status, a negative ecological impact status and a neutral ecological impact status with a user account according to the at least one ecological impact quantification. For example, in an exemplary embodiment, user 300 can be given a reward based on an ecological impact quantification associated with the product 101 by associating information that defines a reward with user account 204. For example, and referring to FIG. 2, reward/penalty module 207 can be configured to receive a message from lifecycle module 113 that includes an identifier for user account 204, an identifier for product 101, the ecological impact quantification associated with that product 101, etc. The reward/penalty module 207 can parse the message; lookup product 101; and compare the ecological impact quantification to a threshold. In this example, reward/penalty module 207 can determine to grant user 300 a reward and store information indicative of a reward in reward/penalty information table 208. In an exemplary embodiment, the reward could be an account credit, information that causes a third party to grant enhanced level of service to user 300, e.g., decreased utility rates. Once the information is stored in reward/penalty information table 208, user 300 may access it via a web-page that displays user account 204. In some instances, user 300 may print off tickets or other printable rewards.

In a specific example, suppose user 300 is a product manufacturer 102 who manufactures a laptop computer product efficiently in that it minimizes its ecological impact quantification (e.g. a CO₂e footprint). For example, the laptop may include reduced levels of rare or hazardous materials, may include subcomponents manufactured locally to minimize transportation impact, etc. In this example, such product information may be provided by the product specification module 501 to ecological impact regulation entity 106. Following computation of an ecological impact quantification associated with the manufacture of the product, the ecological impact quantification can be routed to reward/penalty module 207, which can compare the ecological impact quantification to a threshold. In this example, the reward/penalty module 207 determines that the ecological impact quantification is associated with a reward to reflect that the laptop is being manufactured in an ecologically friendly manner. A reward may then be associated with a user account 204 associated with user 300.

Alternatively, user 300 can be assessed a penalty based on the ecological impact quantification associated with the product 101. For example, and referring to FIG. 2, reward/penalty module 207 can be configured to receive a message from lifecycle module 113 that includes an identifier for user account 204, an identifier for product 101, the ecological impact quantification associated with that product 101, etc. The reward/penalty module 207 can parse the message; lookup product 101; and compare the ecological impact quantification to a threshold. In this example, reward/penalty module 207 can determine to assess user 300 a penalty and store information indicative of a penalty in reward/penalty information table 208. In an exemplary embodiment, the reward could be a monetary penalty. Once the information is stored in reward/penalty information table 208, user 300 may access it via a web-page that displays user account 204.

In a specific example, suppose user 300 is a product manufacturer 102 who manufactures an automobile product inefficiently in that does not minimize its ecological impact quantification (e.g. a CO₂e footprint). For example, the automobile may operate on a low miles-per-gallon basis, may include subcomponents manufactured worldwide thereby failing to minimize transportation impact, etc. In this example, such product information may be provided by the product specification module 501 to ecological impact regulation entity 106. Following computation of an ecological impact quantification associated with the manufacture of the product, the ecological impact quantification can be routed to reward/penalty module 207, which can compare the ecological impact quantification to a threshold. In this example, the reward/penalty module 207 determines that the ecological impact quantification is associated with a penalty to reflect that the automobile is being manufactured in an ecologically unfriendly manner. A penalty may then be associated with a user account 204 associated with user 300.

Alternatively, user 300 a neutral ecological impact status indicator may be associated with user account 204 based on the ecological impact quantification associated with the product 101. For example, and referring to FIG. 2, reward/penalty module 207 can be configured to receive a message from lifecycle module 113 that includes an identifier for user account 204, an identifier for product 101, the ecological impact quantification associated with that product 101, etc. The reward/penalty module 207 can parse the message; lookup product 101; and compare the ecological impact quantification to a threshold. In this example, reward/penalty module 207 can determine that the ecological impact quantification associated with the product may fall within a threshold ecological impact quantification range indicative of compliance with an established (e.g. legislative or regulatory imposed) ecological impact quantification. Data associated with such compliance is stored in reward/penalty information table 208, user 300 may access it via a web-page that displays user account 204.

In a specific example, suppose user 300 is a product manufacturer 102 who manufactures a product 101 (e.g. a fuel composition such as gasoline, coal, and the like) subject to legislative or regulatory ecological impact limit (e.g. sulfur content, etc.). It may be the case that product manufacturer 102 manufactures the product 101 to contain components falling within the allowable legislative or regulatory ecological impact limit. In this example, such product information may be provided by the product specification module 501 to ecological impact regulation entity 106. Following computation of an ecological impact quantification associated with the manufacture of the product, the ecological impact quantification can be routed to reward/penalty module 207, which can compare the ecological impact quantification to a threshold associated with the allowable ecological impact range. In this example, the reward/penalty module 207 determines that the ecological impact quantification is within the allowable ecological impact range. A neutral ecological impact status indicator may be associated with user account 204 associated with user 300.

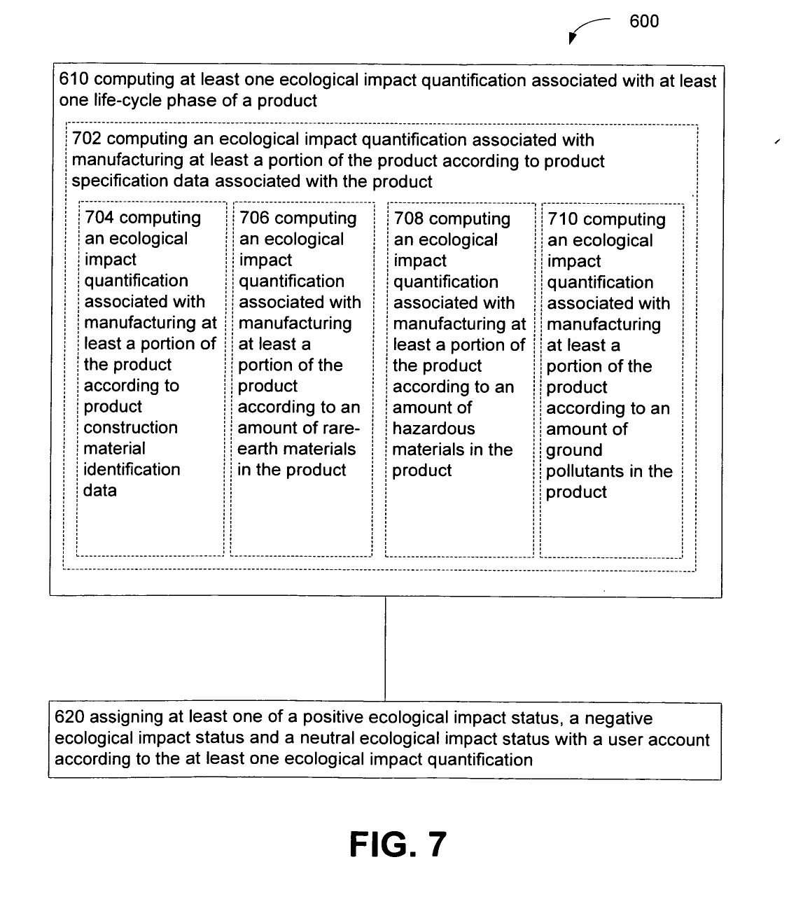

FIG. 7 illustrates an example embodiment where operation 610 of the example operational flow 600 of FIG. 6 may include at least one additional operation. Additional operations may include an operation 702, 704, 706 and/or 708.

Operation 702 shows computing an ecological impact quantification associated with manufacturing at least a portion of the product according to product specification data associated with the product. As shown in FIG. 5, the product specification module 501 may receive product specification data (e.g. user inputs from designers, process engineers, business executives) defining one or more manufacturing characteristics associated with a product 101 (e.g. construction materials, materials transportation data, energy use associated with product manufacturing). The product specification module 501 may provide the product specification data to a lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with the product specification data for the product 101 from maintained in product information database 212 of database 108.

For example, the product specification data may include raw materials used in the manufacture of product 101. The lifecycle module 113 may query the hazardous materials table 214 of database 108 to determine if any of the raw materials are classified as hazardous materials. Upon a determination that one or more raw materials constitute the lifecycle module 113 may compare the amount of raw material classified as hazardous materials to a threshold amount of hazardous materials maintained in threshold table 225. Should the amount of raw material classified as hazardous materials be below the threshold amount of hazardous materials, it may be indicative of a reduced ecological impact associated with the manufacturing of the product 101. Should the amount of raw material classified as hazardous materials be above the threshold amount of hazardous materials, it may be indicative of an increased ecological impact associated with the manufacturing of the product 101. The lifecycle module 113 may compute an ecological impact quantification according to the comparison between the amount of raw material classified as hazardous materials and the threshold amount of hazardous materials. For example, an amount of raw material classified as hazardous materials below the threshold amount of hazardous materials may be mapped to an ecological impact quantification of “1”, an amount of raw material classified as hazardous materials substantially equal to the threshold amount of hazardous materials may be mapped to an ecological impact quantification of “2” and an amount of raw material classified as hazardous materials above the threshold amount of hazardous materials may be mapped to an ecological impact quantification of “3.”

In an alternate example, the product specification data may include data associated with the transportation of quantity raw materials used in the manufacture of product 101. The lifecycle module 113 may query the CO₂e table 216 of database 108 to determine the CO₂e value associated with transporting an amount of raw material a given distance. Upon a determination of the CO₂e value associated with transporting an amount of raw material a given distance, lifecycle module 113 may compare the CO₂e value to a threshold CO₂e value maintained in threshold table 225. Should the CO₂e value associated with transporting an amount of raw material the given distance be below the threshold CO₂e value, it may be indicative of a reduced ecological impact associated with the manufacturing of the product 101. Should the CO₂e value associated with transporting the amount of raw material the given distance be above the threshold CO₂e value, it may be indicative of an increased ecological impact associated with the manufacturing of the product 101. The lifecycle module 113 may compute an ecological impact quantification according to the comparison between the CO₂e value associated with transporting the amount of raw material the given distance and the threshold CO₂e value. For example, a CO₂e value associated with transporting the amount of raw material the given distance below the threshold CO₂e value may be mapped to an ecological impact quantification of “1”, a CO₂e value associated with transporting the amount of raw material the given distance equal to the threshold CO₂e value may be mapped to an ecological impact quantification of “2” and a CO₂e value associated with transporting the amount of raw material the given distance above the threshold CO₂e value may be mapped to an ecological impact quantification of “3.”

Operation 704 shows computing an ecological impact quantification associated with manufacturing at least a portion of the product according to product construction material identification data. For example, the product specification data received via the product specification module 501 may include raw materials used in the manufacture of product 101. The lifecycle module 113 may query the product information database 212 of database 108 to determine various ecological impact characteristics of the raw materials used in the manufacture of product 101. The lifecycle module 113 may compare the amount of a given raw material to a threshold amount (e.g. as governmentally recommended amount) of the given raw materials maintained in threshold table 225. Should the amount of raw material be below the threshold allowable amount of the given raw material, it may be indicative of a reduced ecological impact associated with the manufacturing of the product 101. Should the amount of the given raw material be above the threshold amount, it may be indicative of an increased ecological impact associated with the manufacturing of the product 101. The lifecycle module 113 may compute an ecological impact quantification according to the comparison between the amount of raw material and the threshold amount of raw materials. For example, an amount of the given raw material below the threshold amount may be mapped to an ecological impact quantification of “1”, an amount of the given raw material substantially equal to the threshold amount may be mapped to an ecological impact quantification of “2” and an amount of the given raw material above the threshold amount may be mapped to an ecological impact quantification of “3.”

Operation 706 shows computing an ecological impact quantification associated with manufacturing at least a portion of the product according to an amount of rare-earth materials in the product. For example, the product specification data received via the product specification module 501 may include raw materials used in the manufacture of product 101. The lifecycle module 113 may query the rare materials table 213 of database 108 to determine whether any of the raw materials used in the manufacture of product 101 are classified as rare-earth materials. The lifecycle module 113 may compare the amount of raw material classified as rare-earth materials to a threshold amount of rare-earth materials maintained in threshold table 225. Should the amount of rare-earth material in product 101 be below a threshold allowable amount of the rare-earth material, it may be indicative of a reduced ecological impact associated with the manufacturing of the product 101. Should the amount of the rare-earth material in product 101 be above the threshold amount, it may be indicative of an increased ecological impact associated with the manufacturing of the product 101. The lifecycle module 113 may compute an ecological impact quantification according to the comparison between the amount of rare-earth material and the threshold amount of rare-earth materials. For example, an amount rare-earth material below the threshold amount may be mapped to an ecological impact quantification of “1”, an amount rare-earth material substantially equal to the threshold amount may be mapped to an ecological impact quantification of “2” and an amount of rare-earth material above the threshold amount may be mapped to an ecological impact quantification of “3.”

Operation 708 shows computing an ecological impact quantification associated with manufacturing at least a portion of the product according to an amount of hazardous materials in the product. For example, the product specification data received via the product specification module 501 may include raw materials used in the manufacture of product 101. The lifecycle module 113 may query the hazardous materials table 214 of database 108 to determine whether any of the raw materials used in the manufacture of product 101 are classified as hazardous materials. The lifecycle module 113 may compare the amount of a raw material classified as hazardous materials to a threshold amount of hazardous materials maintained in threshold table 225. Should the amount of hazardous material in product 101 be below a threshold allowable amount of the hazardous material, it may be indicative of a reduced ecological impact associated with the manufacturing of the product 101. Should the amount of the hazardous material in product 101 be above the threshold amount, it may be indicative of an increased ecological impact associated with the manufacturing of the product 101. The lifecycle module 113 may compute an ecological impact quantification according to the comparison between the amount of hazardous material and the threshold amount of hazardous materials. For example, an amount hazardous material below the threshold amount may be mapped to an ecological impact quantification of “1”, an amount hazardous material substantially equal to the threshold amount may be mapped to an ecological impact quantification of “2” and an amount of hazardous material above the threshold amount may be mapped to an ecological impact quantification of “3.”

Operation 710 shows computing an ecological impact quantification associated with manufacturing at least a portion of the product according to an amount of ground pollutants in the product. For example, the product specification data received via the product specification module 501 may include raw materials used in the manufacture of product 101. The lifecycle module 113 may query the ground pollutant table 215 of database 108 to determine whether any of the raw materials used in the manufacture of product 101 are classified as ground pollutant materials. The lifecycle module 113 may compare the amount of a raw material classified as ground pollutant materials to a threshold amount of ground pollutant materials maintained in threshold table 225. Should the amount of ground pollutant material in product 101 be below a threshold allowable amount of the ground pollutant material, it may be indicative of a reduced ecological impact associated with the manufacturing of the product 101. Should the amount of the ground pollutant material in product 101 be above the threshold amount, it may be indicative of an increased ecological impact associated with the manufacturing of the product 101. The lifecycle module 113 may compute an ecological impact quantification according to the comparison between the amount of ground pollutant material and the threshold amount of ground pollutant materials. For example, an amount ground pollutant material below the threshold amount may be mapped to an ecological impact quantification of “1”, an amount ground pollutant material substantially equal to the threshold amount may be mapped to an ecological impact quantification of “2” and an amount of ground pollutant material above the threshold amount may be mapped to an ecological impact quantification of “3.”

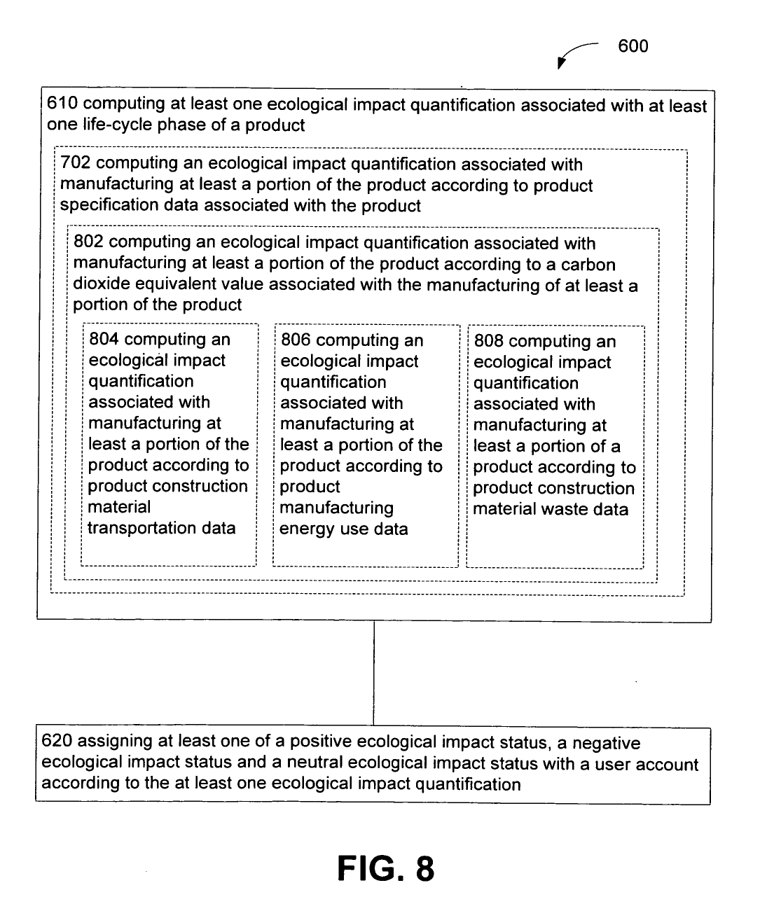

FIG. 8 illustrates an example embodiment where the operation 702 of example operational flow 600 of FIG. 7 may include at least one additional operation. Additional operations may include operations 802, 804 and/or 806.

Operation 802 shows computing an ecological impact quantification associated with manufacturing at least a portion of the product according to a carbon dioxide equivalent value associated with the manufacturing of at least a portion of the product. For example, the product specification data received via the product specification module 501 may include manufacturing process steps for manufacturing the product 101 and/or parameters associated with those manufacturing process steps. The lifecycle module 113 may query the CO₂e table 216 of database 108 to determine a CO₂e value associated with a manufacturing process step for the product 101. Upon a determination of the CO₂e value associated with the manufacturing process step, lifecycle module 113 may compare the CO₂e value to a threshold CO₂e value maintained in threshold table 225. Should the CO2e value associated with the manufacturing process step be below the threshold CO₂e value, it may be indicative of a reduced ecological impact associated with the manufacturing of the product 101. Should the CO₂e value associated with the manufacturing process step be above the threshold CO₂e value, it may be indicative of an increased ecological impact associated with the manufacturing of the product 101. The lifecycle module 113 may compute an ecological impact quantification according to a comparison between the CO₂e value associated with the manufacturing process step and the threshold CO₂e value. For example, a CO₂e value associated with the manufacturing process step below the threshold CO₂e value may be mapped to an ecological impact quantification of “1”, a CO₂e value associated with the manufacturing process step to the threshold CO₂e value may be mapped to an ecological impact quantification of “2” and a CO₂e value associated with the manufacturing process step above the threshold CO₂e value may be mapped to an ecological impact quantification of “3.”

Operation 804 shows computing an ecological impact quantification associated with manufacturing at least a portion of the product according to product construction material transportation data. For example, the product specification data received via the product specification module 501 may include product construction material transportation data (e.g. material transportation mileage, material transportation method (e.g. rail, truck, ship, aircraft, etc.) associated with manufacturing the product 101. The lifecycle module 113 may query the CO₂e table 216 of database 108 to determine the CO₂e value associated with the product construction material transportation data. Upon a determination of the CO₂e value associated with the product construction material transportation data, lifecycle module 113 may compare the CO₂e value to a threshold CO₂e value maintained in threshold table 225. Should the CO2e value associated with the product construction material transportation data be below the threshold CO₂e value, it may be indicative of a reduced ecological impact associated with the manufacturing of the product 101. Should the CO₂e value associated with the product construction material transportation data be above the threshold CO₂e value, it may be indicative of an increased ecological impact associated with the manufacturing of the product 101. The lifecycle module 113 may compute an ecological impact quantification according to a comparison between the CO₂e value associated with the product construction material transportation data and the threshold CO₂e value. For example, a CO₂e value associated with the product construction material transportation data below the threshold CO₂e value may be mapped to an ecological impact quantification of “1”, a CO₂e value associated with the product construction material transportation data to the threshold CO₂e value may be mapped to an ecological impact quantification of “2” and a CO₂e value associated with the product construction material transportation data above the threshold CO₂e value may be mapped to an ecological impact quantification of “3.”

Operation 806 shows computing an ecological impact quantification associated with manufacturing at least a portion of the product according to product manufacturing energy use data. For example, the product specification data received via the product specification module 501 may include product manufacturing energy use data (e.g. process step parameters (e.g. process step durations, temperatures, pressures) energy consumption rates for a process step, energy sources supplying the energy, etc.) associated with manufacturing the product 101. The lifecycle module 113 may query the CO₂e table 216 of database 108 to determine the CO₂e value associated with the product manufacturing energy use data. Upon a determination of the CO₂e value associated with the product manufacturing energy use data, lifecycle module 113 may compare the CO₂e value to a threshold CO₂e value maintained in threshold table 225. Should the CO2e value associated with the product manufacturing energy use data be below the threshold CO₂e value, it may be indicative of a reduced ecological impact associated with the manufacturing of the product 101. Should the CO₂e value associated with the product manufacturing energy use data be above the threshold CO₂e value, it may be indicative of an increased ecological impact associated with the manufacturing of the product 101. The lifecycle module 113 may compute an ecological impact quantification according to a comparison between the CO₂e value associated with the product manufacturing energy use data and the threshold CO₂e value. For example, a CO₂e value associated with the product manufacturing energy use data below the threshold CO₂e value may be mapped to an ecological impact quantification of “1”, a CO₂e value associated with the product manufacturing energy use data to the threshold CO₂e value may be mapped to an ecological impact quantification of “2” and a CO₂e value associated with the product manufacturing energy use data above the threshold CO₂e value may be mapped to an ecological impact quantification of “3.”

Operation 808 shows computing an ecological impact quantification associated with manufacturing at least a portion of the product according to product construction material waste data. For example, the product specification data received via the product specification module 401 may include product construction material waste data (e.g. product raw material acquisition amounts, product raw material manufacturing usage amounts, raw materials waste amounts, waste disposal methodologies (e.g. recycling, landfill, incineration, etc.) associated with manufacturing the product 102. The LCM 118/418 may query the CO₂e table 206 of database 114/414 to determine the CO₂e value associated with the product construction material waste data. Upon a determination of the CO₂e value associated with the product construction material waste data, LCM 118/418 may compare the CO₂e value to a threshold CO₂e value maintained in threshold table 234. Should the CO2e value associated with the product construction material waste data be below the threshold CO₂e value, it may be indicative of a reduced ecological impact associated with the manufacturing of the product 102. Should the CO₂e value associated with the product construction material waste data be above the threshold CO₂e value, it may be indicative of an increased ecological impact associated with the manufacturing of the product 102. The LCM 118/418 may compute an ecological impact quantification according to a comparison between the CO₂e value associated with the product construction material waste data and the threshold CO₂e value. For example, a CO₂e value associated with the product construction material waste data below the threshold CO₂e value may be mapped to a ecological impact quantification of “1”, a CO₂e value associated with the product construction material waste data to the threshold CO₂e value may be mapped to an ecological impact quantification of “2” and a CO₂e value associated with the product construction material waste data above the threshold CO₂e value may be mapped to a ecological impact quantification of “3.”

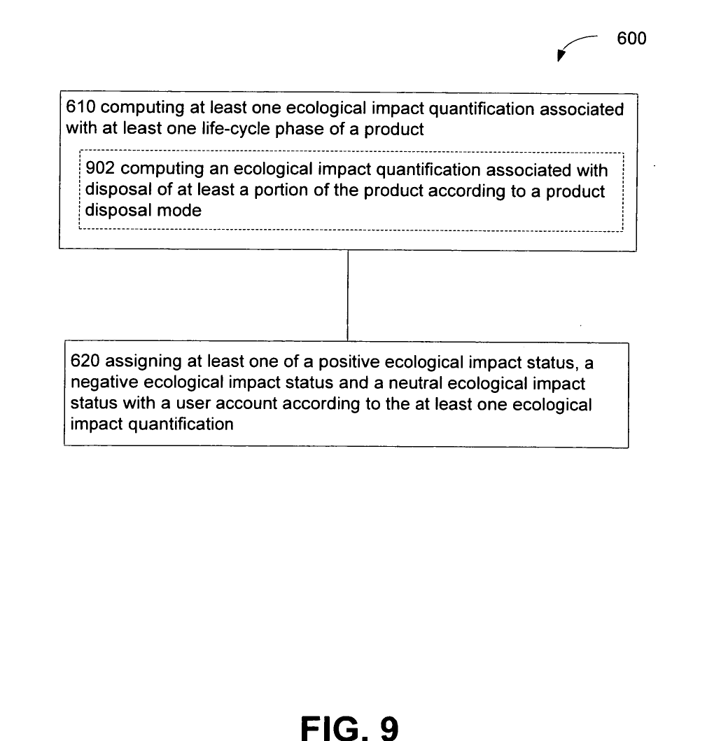

FIG. 9 illustrates an example embodiment where the operation 610 of example operational flow 600 of FIG. 6 may include at least one additional operation. Additional operations may include operation 902.

Operation 902 shows computing an ecological impact quantification associated with disposal of at least a portion of the product according to a product disposal mode. For example, the product specification module 501 may receive product specification data (e.g. user inputs from designers, process engineers, business executives) defining one or more manufacturing characteristics associated with a product 101 (e.g. construction materials). The product specification module 501 may provide the product specification data to a lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with disposal of at least a portion of the product according to a product disposal mode from the product information repository data maintained in database 108.

The product specification data may include raw materials used in the manufacture of product 101. The lifecycle module 113 may query the disposal phase quantification table 219 of database 108 to determine the various disposal mode options for disposing of the product based on the raw materials used in the manufacture of product 101 and assign an ecological impact quantification to one or more disposal modes according to the raw materials used in the manufacture of product 101.

For example, if a product 101 contains a high percentage of recyclable materials, the lifecycle module 113 may compute a relatively low ecological impact quantification for a disposal of the product 101 according to a recycling disposal mode. Alternatively, if a product 101 contains a low percentage of recyclable materials, the lifecycle module 113 may compute a relatively high ecological impact quantification for a disposal of the product 101 according to a recycling disposal mode.

As a further example, if a product 101 contains a high percentage of hazardous materials, the lifecycle module 113 may compute a relatively high ecological impact quantification for a disposal of the product 101 according to a landfill disposal mode. Alternatively, if a product 101 contains a high percentage of hazardous materials, the lifecycle module 113 may compute a relatively low ecological impact quantification for a disposal of the product 101 according to an incineration disposal mode.

Following computation of ecological impact quantifications associated with various product specification data types, those individual ecological impact quantifications may be aggregated (e.g. summed, averaged, weighted average) to provide an overall ecological impact quantification for the manufacture of the product 101. Upon association of a product 101 with a user 300 (as described above with respect to operation 610), the ecological impact quantification for the product 101 (e.g. manufacturing and/or disposal ecological impact quantifications) may be stored to a user account 204 associated with the user 300.

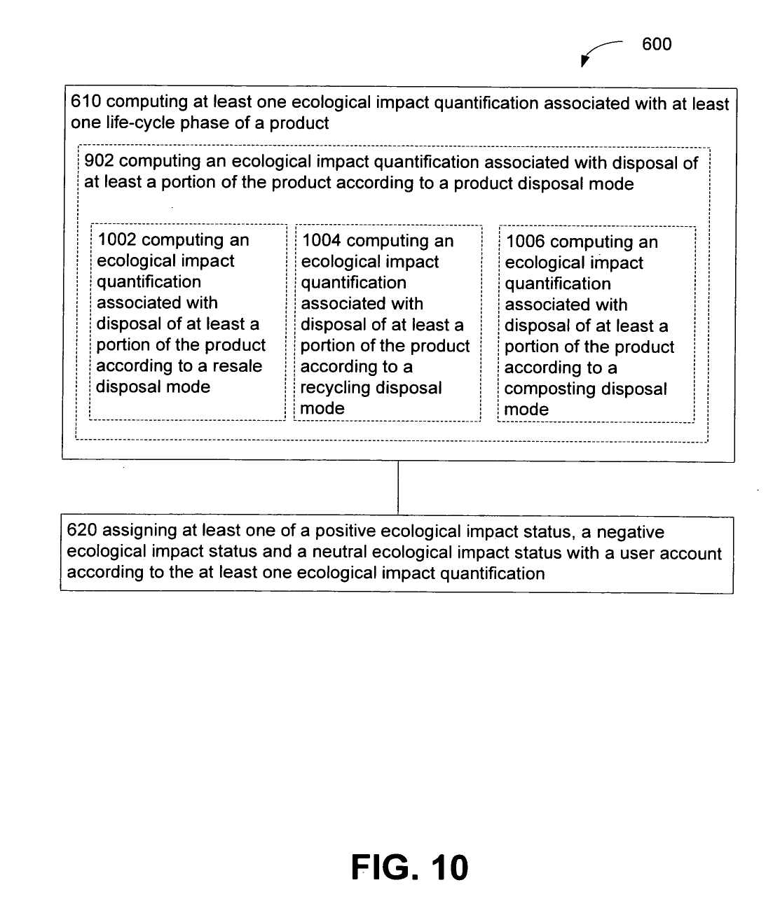

FIG. 10 illustrates an example embodiment where the operation 902 of example operational flow 600 of FIG. 9 may include at least one additional operation. Additional operations may include operation 1002, 1004 and/or 1006.

Operation 1002 shows computing an ecological impact quantification associated with disposal of at least a portion of the product according to a resale disposal mode. For example as shown in FIGS. 1-5, the product specification module 501 may receive product specification data (e.g. user inputs from designers, process engineers, business executives) defining one or more characteristics associated with a product 101 (e.g. a product lifespan). The product specification module 501 may provide the product specification data to an lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with disposal of at least a portion of the product 101 according to a resale disposal mode from the product information repository data maintained in database 108.

For example, the product 101 (e.g. a battery) may have energy usage properties (e.g. storage capacity) that degrade over its lifespan. In this case, the lifecycle module 113 may compute a time-dependent ecological impact quantification for a disposal of the product 101 according to a resale disposal mode. Specifically, if the lifecycle module 113 determines that the product is relatively close to the beginning of its product lifespan (e.g. by comparing a product manufacturing date to a current date), the lifecycle module 113 may compute a relatively low ecological impact quantification for a disposal of the product 101 according to a resale disposal mode. Alternatively, if a product 101 is nearing the end of its product lifespan, the lifecycle module 113 may compute a relatively high ecological impact quantification (e.g. the ecological impact costs of carrying out the resale transaction (e.g. shipping the product) outweigh the useful portion of the product lifespan) for a disposal of the product 101 according to a resale disposal mode.

Operation 1004 shows computing an ecological impact quantification associated with disposal of at least a portion of the product according to a recycling disposal mode. For example as shown in FIGS. 1-5, the product specification module 501 may receive product specification data (e.g. user inputs from designers, process engineers, business executives) defining one or more manufacturing characteristics associated with a product 101 (e.g. construction materials). The product specification module 501 may provide the product specification data to an lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with disposal of at least a portion of the product 101 according to a product recycling disposal mode from the product information repository data maintained in database 108.

For example, if a product 101 contains a high percentage of recyclable materials, the lifecycle module 113 may compute a relatively low ecological impact quantification for a disposal of the product 101 according to a recycling disposal mode. Alternatively, if a product 101 contains a low percentage of recyclable materials, the lifecycle module 113 may compute a relatively high ecological impact quantification for a disposal of the product 101 according to a recycling disposal mode.

Operation 1006 shows computing an ecological impact quantification associated with disposal of at least a portion of the product according to a composting disposal mode. For example as shown in FIGS. 1-5, the product specification module 501 may receive product specification data (e.g. user inputs from designers, process engineers, business executives) defining one or more manufacturing characteristics associated with a product 101 (e.g. construction materials). The product specification module 501 may provide the product specification data to an lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with disposal of at least a portion of the product 101 according to a composting disposal mode from the product information repository data maintained in database 108.

For example, if a product 101 contains a high percentage of materials that, upon degradation, provide one or more reusable byproduct materials, the lifecycle module 113 may compute a relatively low ecological impact quantification for a disposal of the product 101 according to a composting disposal mode. Alternatively, if a product 101 contains a low percentage of materials that, upon degradation, provide one or more reusable byproduct materials, the lifecycle module 113 may compute a relatively high ecological impact quantification for a disposal of the product 101 according to a composting disposal mode.

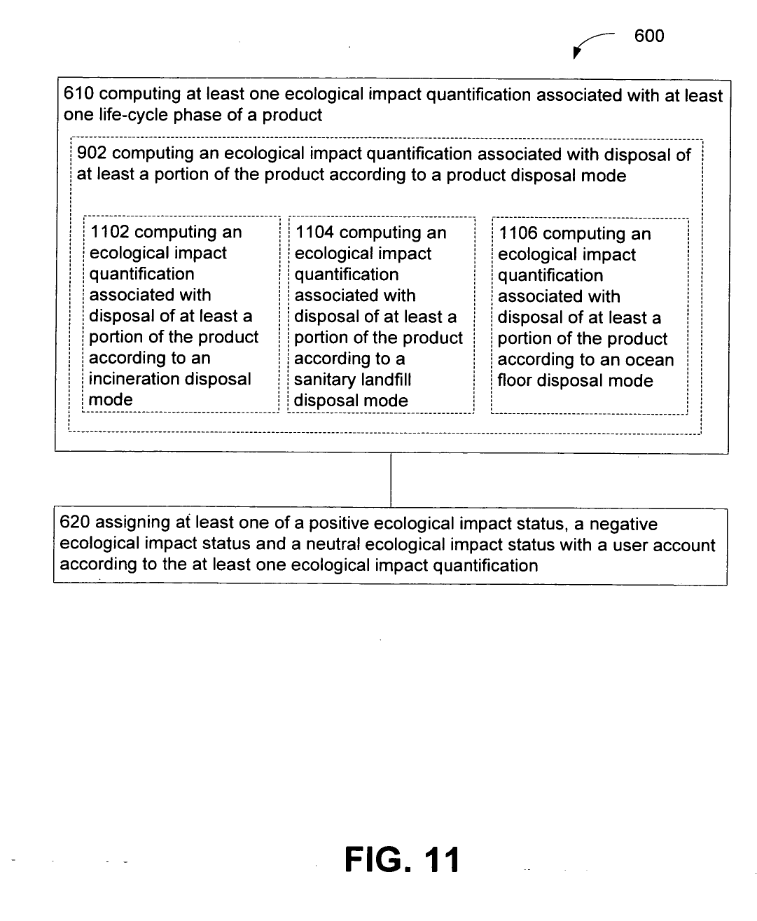

FIG. 11 illustrates an example embodiment where the operation 902 of example operational flow 600 of FIG. 9 may include at least one additional operation. Additional operations may include operation 1102, 1104 and/or 1106.

Operation 1102 shows computing an ecological impact quantification associated with disposal of at least a portion of the product according to an incineration disposal mode. For example as shown in FIGS. 1-5, the product specification module 501 may receive product specification data (e.g. user inputs from designers, process engineers, business executives) defining one or more manufacturing characteristics associated with a product 101 (e.g. construction materials). The product specification module 501 may provide the product specification data to an lifecycle module 113. The lifecycle module 113 may receive product specification data associated with manufacturing the product 101 and correlate that product specification data to product information repository data maintained in product information database 212 of database 108. The lifecycle module 113 may compute an ecological impact quantification associated with disposal of at least a portion of the product according to an incineration disposal mode from the product information repository data maintained in database 108.

For example, if a product 101 contains a high percentage of materials that, upon exposure to excessive heat, generate one or more hazardous byproducts or are highly explosive, the lifecycle module 113 may compute a relatively high ecological impact quantification for a disposal of the product 101 according to an incineration disposal mode. Alternatively, if a product 101 contains a low percentage of materials that, upon degradation, upon exposure to excessive heat, generate one or more hazardous byproducts or are highly explosive, the lifecycle module 113 may compute a relatively low ecological impact quantification for a disposal of the product 101 according to a composting disposal mode.

Operation 1104 shows computing an ecological impact quantification associated with disposal of at least a portion of the product according to a sanitary landfill disposal mode. For example as shown in FIGS. 1-5, the product specification module 501 may receive product specification data (e.g. user inputs from designers, process engineers, business executives) defining one or more manufacturing characteristics associated with a product 101 (e.g. construction materials). The product specification module 501 may provide the product specification data to an lifecycle module 113. The lifecycle module 113 may receive product specification data associated with manufacturing the product 101 and correlate that product specification data to product information repository data maintained in product information database 212 of database 108/database 511. The lifecycle module 113 may compute an ecological impact quantification associated with disposal of at least a portion of the product 101 according to a landfilling disposal mode from the product information repository data maintained in database 108.

For example, if a product 101 contains a high percentage of biodegradable materials, the lifecycle module 113 may compute a relatively low ecological impact quantification for a disposal of the product 101 according to an incineration disposal mode. Alternatively, if a product 101 contains a low percentage of biodegradable materials, the lifecycle module 113 may compute a relatively high ecological impact quantification for a disposal of the product 101 according to a composting disposal mode.

Operation 1106 shows computing an ecological impact quantification associated with disposal of at least a portion of the product according to an ocean floor disposal mode. For example as shown in FIGS. 1-5, the product specification module 501 may receive product specification data (e.g. user inputs from designers, process engineers, business executives) defining one or more manufacturing characteristics associated with a product 101 (e.g. construction materials). The product specification module 501 may provide the product specification data to an lifecycle module 113. The lifecycle module 113 may receive product specification data associated with manufacturing the product 101 and correlate that product specification data to product information repository data maintained in product information database 212 of database 108/database 511. The lifecycle module 113 may compute an ecological impact quantification associated with disposal of at least a portion of the product 101 according to an ocean floor disposal mode from the product information repository data maintained in database 108.

For example, if a product 101 contains a high percentage of water-soluble materials, the lifecycle module 113 may compute a relatively low ecological impact quantification for a disposal of the product 101 according to an incineration disposal mode. Alternatively, if a product 101 contains a low percentage of water-soluble materials, the lifecycle module 113 may compute a relatively high ecological impact quantification for a disposal of the product 101 according to a composting disposal mode.

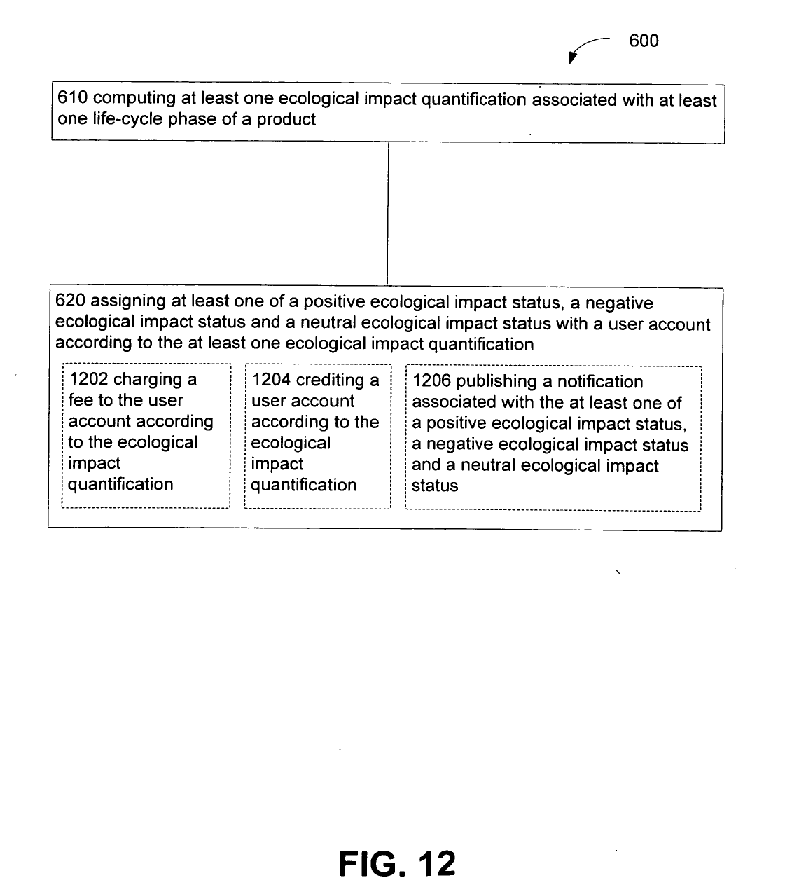

FIG. 12 illustrates an example embodiment where the operation 620 of example operational flow 600 of FIG. 6 may include at least one additional operation. Additional operations may include an operation 1202, 1204, 1206 and/or 1208.

Operation 1202 shows charging a fee to the user account according to the ecological impact quantification. Again referring to FIG. 2, accounting module 209 can be configured to compute a fee that is a relative fee, i.e., a fee that is based on efficiency-of-use scores and/or ecological impact quantifications associated with uses of the product 101 before user 300. For example, score history database 213 can store an efficiency-of-use score and/or ecological impact quantification history for each product, such as product 101. For example, each time efficiency-of-use module 202 generates an efficiency-of-use score for product 101 or the lifecycle module 113 generates an ecological impact quantification for product 101, a message can be generated that includes an identifier for product 101, the efficiency-of-use score and/or ecological impact quantification. The message can be sent to score history database 213, which can include logic for parsing the message and updating a history for product 101. In this exemplary configuration, when an efficiency-of-use score is computed it can be sent via a message to accounting module 209. The accounting module 209 can receive the message and access score history database 213 in order to compute a fee that is based on prior use of product 101. For example, the fee could be based on a threshold. In this configuration, if the score associated with use of product 101 by user 300 is worse than the average, mean, etc., score of two or more prior users, a fee can be charged. In another example, the fee can be based on the difference between the score for user 300 and the average, mean, etc., score of two or more prior users 300.

Operation 1204 shows crediting a user account according to the ecological impact quantification. Again referring to FIG. 2, accounting module 209 can be configured to compute an account credit (e.g. a refund) that is a relative credit, i.e., a credit that is based on efficiency-of-use scores and/or ecological impact quantifications associated with uses of the product 101 before user 300. For example, score history database 213 can store an efficiency-of-use score and/or ecological impact quantification history for each product, such as product 101. For example, each time efficiency-of-use module 202 generates an efficiency-of-use score for product 101 or the lifecycle module 113 generates an ecological impact quantification for product 101, a message can be generated that includes an identifier for product 101, the efficiency-of-use score and/or ecological impact quantification. The message can be sent to score history database 213, which can include logic for parsing the message and updating a history for product 101. In this exemplary configuration, when an efficiency-of-use score is computed it can be sent via a message to accounting module 209. The accounting module 209 can receive the message and access score history database 213 in order to compute an account credit that is based on prior use of product 101. For example, the account credit could be based on a threshold. In this configuration, if the score associated with use of product 101 by user 300 is better than the average, mean, etc., score of two or more prior users, a account credit can be applied. In another example, the fee can be based on the difference between the score for user 300 and the average, mean, etc., score of two or more prior users 300.

Operation 1206 shows generating a webpage indicative of the at least one of a positive ecological impact status, a negative ecological impact status and a neutral ecological impact status. For example, in an exemplary embodiment, user 300 can be given a reward based on his or her efficiency-of-use score and/or ecological impact quantification by associating information that defines a reward with his or her user account, e.g., user account 204. For example, and referring to FIG. 2, reward/penalty module 207 can be configured to receive a message from efficiency-of-use module 202 and/or lifecycle module 113 that includes an identifier for user account 204, an identifier for product 101, the efficiency-of-use score, ecological impact quantification, etc. The reward/penalty module 207 can parse the message; lookup product 101; and compare the efficiency-of-use score and/or the ecological impact quantification to a threshold. In this example, reward/penalty module 207 can determine to grant user 300 a reward. In an exemplary embodiment a trophy icon (e.g. a green leaf) may be associated with an identifier (e.g. a user name) associated with the user 300 to indicate that the product 101 is being used efficiently by user 300 and published on a webpage maintained by web-server module 222 such that users 300 may view the icon.

In an alternate exemplary embodiment, user 300 can be assessed a penalty based on his or her efficiency-of-use score and/or ecological impact quantification by associating information that defines a penalty with his or her user account, e.g., user account 204. For example, and referring to FIG. 2, reward/penalty module 207 can be configured to receive a message from efficiency-of-use module 202 and/or lifecycle module 113 that includes an identifier for user account 204, an identifier for product 101, the efficiency-of-use score, ecological impact quantification, etc. The reward/penalty module 207 can parse the message; lookup product 101; and compare the efficiency-of-use score and/or the ecological impact quantification to a threshold. In this example, reward/penalty module 207 can determine to assess user 300 a penalty. In an exemplary embodiment a penalty icon (e.g. a gushing oil derrick) may be associated with an identifier (e.g. a user name) associated with the user 300 to indicate that the product 101 is being used inefficiently by user 300 and published on a webpage maintained by web-server module 222 such that users 300 may view the icon.

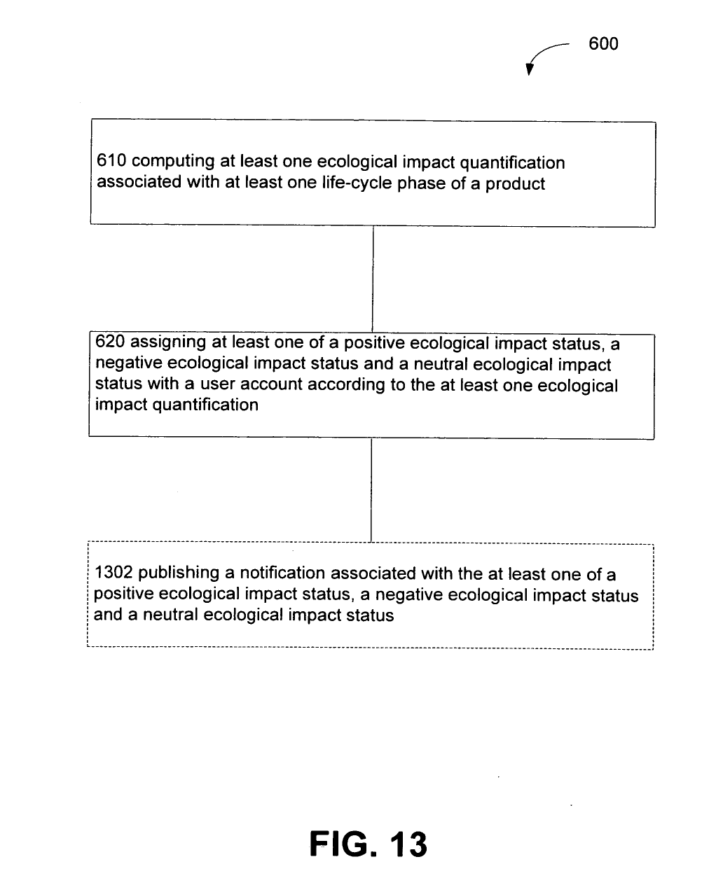

FIG. 13 illustrates an example embodiment where the example operational flow 600 of FIG. 6 may include at least one additional operation. Additional operations may include an operation 1302.

Operation 1302 shows publishing a notification associated with the at least one of a positive ecological impact status, a negative ecological impact status and a neutral ecological impact status. Following the computation of an ecological impact associated with the product 101, a corresponding reward and/or penalty may be published such that the reward and/or penalty may be viewed by the user 300, a group of users 300 and/or the public.

It may be the case that the ecological impact quantification associated with a product 101 may be compared to a prior or contemporaneous ecological impact quantifications of products similar to product 101 to determine whether product 101 is more or less environmentally friendly than the other products or as compared to a standard set by the ecological impact regulation entity 106. In order to affect efficient use of the product 101, it may be desirable to notify users 300 of the relative ecological impact of product 101 relative to the ecological impact of or other products or relative to the standard set by the ecological impact regulation entity 106 so that the user 300 may track/modify the ecological impact of product 101. As such, a notification associated with the reward and/or penalty may be provided to the user 300 so that the user 300 may be made aware of the relative ecological impact of product 101.

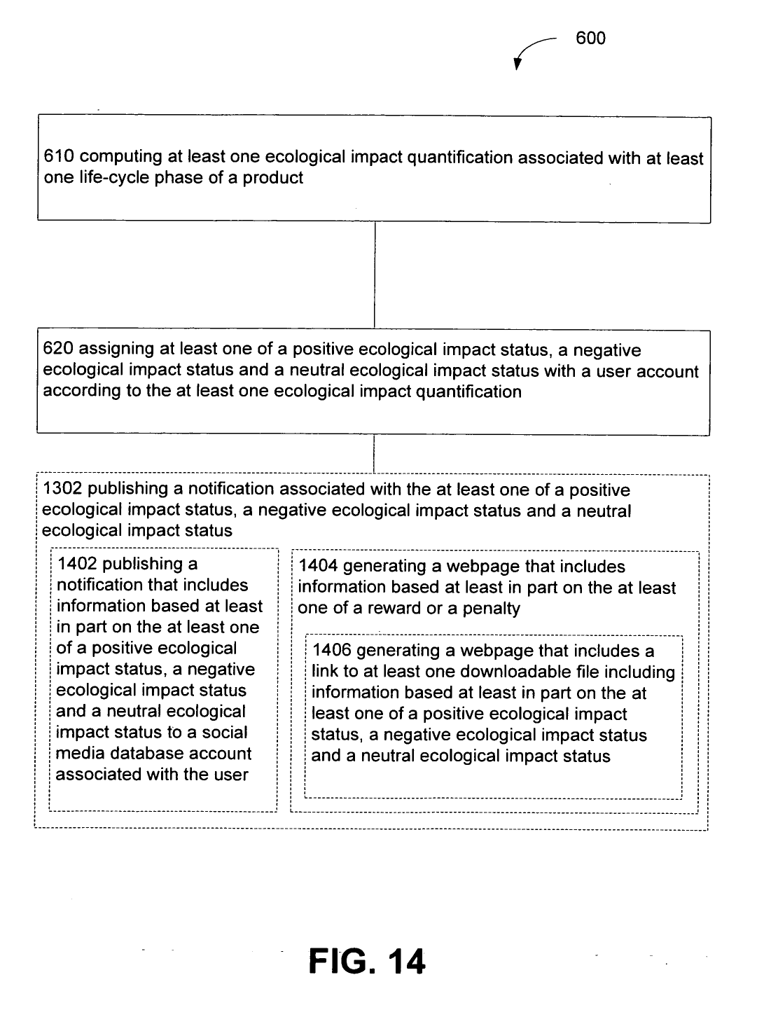

FIG. 14 illustrates an example embodiment where the operation 1302 of example operational flow 600 of FIG. 13 may include at least one additional operation. Additional operations may include an operation 1402, 1404 and/or 1406.

Operation 1402 shows publishing a notification that includes information based at least in part on the at least one of a positive ecological impact status, a negative ecological impact status and a neutral ecological impact status to a social media database account associated with the user. For example, following the computation of an ecological impact associated with the product 101 and a corresponding reward or penalty, a notification associated with a reward or penalty may be published to a social media database (e.g. Facebook®, Twitter®, Google+®, etc.) account associated with (e.g. registered to) at least one user 300 via social networking module 111. For example, a notification associated with the reward or penalty by a may be automatically posted to the social media database account of user 300 (e.g. a Twitter® “tweet” or a Facebook® “status update”) so that individuals having access to the social media database account of user 300 may view the notification.

Operation 1404 shows generating a webpage that includes information based at least in part on the at least one of a positive ecological impact status, a negative ecological impact status and a neutral ecological impact status. For example, system 107 can include web-server module 222, which can be configured to generate a web-page that can include information that is based at least in part on ecological impact associated with the product 101 and a corresponding reward or penalty. For example, the web-page could include a listing of rewards and/or penalties for products 101 manufactured by one or more users 300, cumulative rewards and/or penalties associated with user account 204, etc.

Operation 1406 shows generating a webpage that includes a link to at least one downloadable file including information based at least in part on the at least one of a positive ecological impact status, a negative ecological impact status and a neutral ecological impact status. For example, system 107 can include web-server module 222, which can be configured to generate a web-page that can include links to one or more files (e.g. .Portable Document Format (PDF) files, word processing files, spreadsheet files) that are based at least in part on ecological impact associated with the product 101 and a corresponding reward or penalty. For example, the web-page could include a link to a PDF file listing compliance data associated with legislative and/or regulatory limits for ecological impact for products 101 manufactured by one or more users 300, etc.

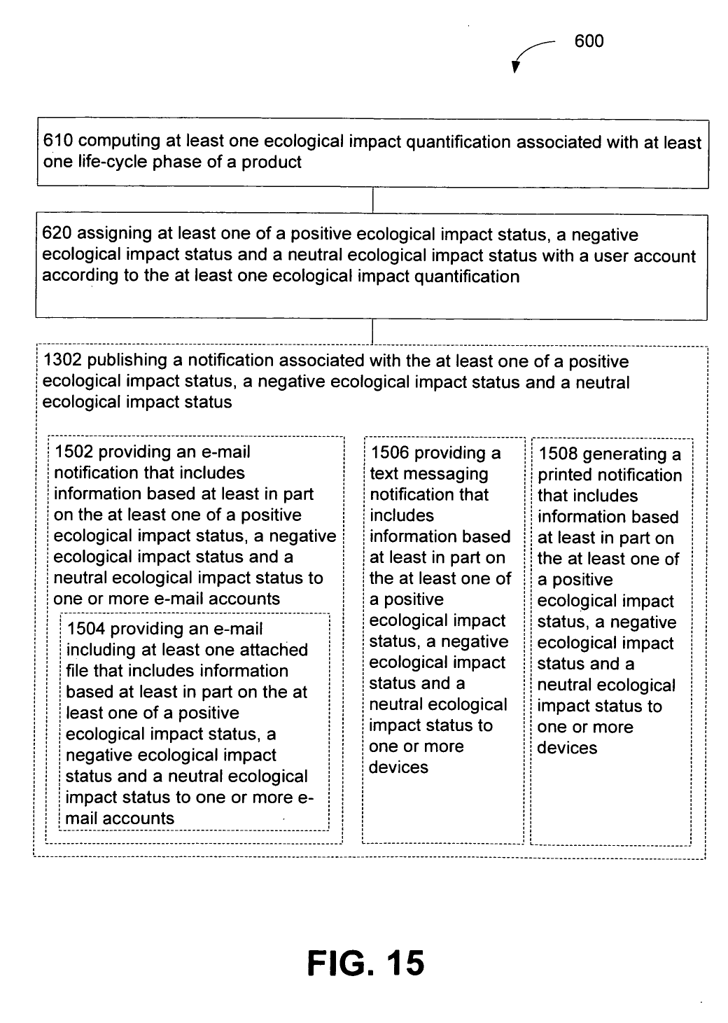

FIG. 15 illustrates an example embodiment where the operation 1302 of example operational flow 600 of FIG. 13 may include at least one additional operation. Additional operations may include an operation 1502, 1504, 1506 and/or 1508.

Operation 1502 shows providing an e-mail notification that includes information based at least in part on the at least one of a positive ecological impact status, a negative ecological impact status and a neutral ecological impact status to one or more e-mail accounts. For example, following the computation of an ecological impact associated with the product 101 and a corresponding reward or penalty, the email module 112 of the system 107 may transmit an e-mail message via network 100 to an e-mail server (not shown) maintaining an e-mail account associated (e.g. registered to) at least one user 300 of product 101 according to any number of e-mail protocols (e.g. IMAP, POP3, SMTP and HTTP protocols). For example, following the manufacture of the product 101 by user 300, an e-mail message that includes a notification of a reward and/or penalty associated the product 101 may be sent to the e-mail accounts of a user 300.

Operation 1504 shows providing an e-mail including at least one attached file that includes information based at least in part on the at least one of a positive ecological impact status, a negative ecological impact status and a neutral ecological impact status to one or more e-mail accounts. For example, following the computation of an ecological impact quantification associated with the product 101 and a corresponding ecological impact status, the email module 112 of the system 107 may transmit an e-mail message including one or more attached files including information based on the ecological impact status via network 100 to an e-mail server (not shown) maintaining an e-mail account associated (e.g. registered to) at least one user 300 of product 101 according to any number of e-mail protocols (e.g. IMAP, POP3, SMTP and HTTP protocols). For example, following the manufacture of the product 101 by user 300, an e-mail message that includes a attached PDF file including reward and/or penalty information associated the ecological impact quantification of the product 101 may be sent to an e-mail accounts of a user 300.

Operation 1506 shows providing a text messaging notification that includes information based at least in part on the at least one of a positive ecological impact status, a negative ecological impact status and a neutral ecological impact status to one or more devices. For example, following the computation of an ecological impact associated with the product 101 and a corresponding ecological impact status, the system 107 may transmit a text message via network 100 to a device 309 associated with (e.g. owned by) at least one user 300 according to any number of text messaging protocols (e.g. SMS text message protocols). For example, following a disposal of a product 101, a text message that includes a reward and/or penalty associated with the disposal of the product 101 may be sent to a device 309 associated with a user 300.

Operation 1508 shows generating a printed notification that includes information based at least in part on the at least one of a positive ecological impact status, a negative ecological impact status and a neutral ecological impact status to one or more devices. For example, following the computation of an ecological impact associated with the product 101 and a corresponding ecological impact status, the system 107 may print out a physical copy (e.g. a report) including information based on the ecological impact status. For example, following a disposal of a product 101, a printer device (not shown) may print out a paper copy of an ecological impact status report (e.g. a list of fees and/or credits) associated with a user account 204.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed:

1. A system comprising:
means for computing at least one ecological impact quantification associated with at least one life-cycle phase of a product; and
means for assigning at least one of a positive ecological impact status, a negative ecological impact status and a neutral ecological impact status with a user account according to the at least one ecological impact quantification.

2. The system of claim 1, wherein the means for computing at least one ecological impact quantification associated with at least one life-cycle phase of a product comprises:
means for computing an ecological impact quantification associated with manufacturing at least a portion of the product according to product specification data associated with the product.

3. The system of claim 2, wherein the means for computing an ecological impact quantification associated with manufacturing at least a portion of the product according to product specification data associated with the product comprises:
means for computing an ecological impact quantification associated with manufacturing at least a portion of the product according to product construction material identification data.

4. The system of claim 3, wherein the means for computing an ecological impact quantification associated with manufacturing at least a portion of the product according to product construction material identification data comprises:
means for computing an ecological impact quantification associated with manufacturing at least a portion of the product according to an amount of rare-earth materials in the product.

5. The system of claim 3, wherein the means for computing an ecological impact quantification associated with manufacturing at least a portion of the product according to product construction material identification data comprises:
means for computing an ecological impact quantification associated with manufacturing at least a portion of the product according to an amount of hazardous materials in the product.

6. The system of claim 3, wherein the means for computing an ecological impact quantification associated with manufacturing at least a portion of the product according to product construction material identification data comprises:
means for computing an ecological impact quantification associated with manufacturing at least a portion of the product according to an amount of ground pollutants in the product.

7. The system of claim 2, wherein the means for computing an ecological impact quantification associated with manufacturing at least a portion of the product according to product specification data associated with the product comprises:
means for computing an ecological impact quantification associated with manufacturing at least a portion of the product according to a carbon dioxide equivalent value associated with the manufacturing of at least a portion of the product.

8. The system of claim 7, wherein the means for computing an ecological impact quantification associated with manufacturing at least a portion of the product according to a carbon dioxide equivalent value associated with the manufacturing of at least a portion of the product comprises:
means for computing an ecological impact quantification associated with manufacturing at least a portion of the product according to product construction material transportation data.

9. The system of claim 7, wherein the means for computing an ecological impact quantification associated with manufacturing at least a portion of the product according to a carbon dioxide equivalent value associated with the manufacturing of at least a portion of the product comprises:
means for computing an ecological impact quantification associated with manufacturing at least a portion of the product according to product manufacturing energy use data.

10. The system of claim 7, wherein the means for computing an ecological impact quantification associated with manufacturing at least a portion of the product according to product specification data associated with the product comprises:
means for computing an ecological impact quantification associated with manufacturing at least a portion of the product according to product construction material waste data.

11. The system of claim 1, wherein the means for computing at least one ecological impact quantification associated with at least one life-cycle phase of a product comprises:
means for computing an ecological impact quantification associated with disposal of at least a portion of the product according to a product disposal mode.

12. The system of claim 11, wherein the means for computing an ecological impact quantification associated with disposal of at least a portion of the product according to a product disposal mode further comprises:
means for computing an ecological impact quantification associated with disposal of at least a portion of the product according to a resale disposal mode.

13. The system of claim 11, wherein the means for computing an ecological impact quantification associated with disposal of at least a portion of the product according to a product disposal mode further comprises:
means for computing an ecological impact quantification associated with disposal of at least a portion of the product according to a recycling disposal mode.

14. The system of claim 11, wherein the means for computing an ecological impact quantification associated with disposal of at least a portion of the product according to a product disposal mode further comprises:
means for computing an ecological impact quantification associated with disposal of at least a portion of the product according to a composting disposal mode.

15. The system of claim 11, wherein the means for computing an ecological impact quantification associated with disposal of at least a portion of the product according to a product disposal mode further comprises:
means for computing an ecological impact quantification associated with disposal of at least a portion of the product according to an incineration disposal mode.

16. The system of claim 11, wherein the means for computing an ecological impact quantification associated with disposal of at least a portion of the product according to a product disposal mode further comprises:
means for computing an ecological impact quantification associated with disposal of at least a portion of the product according to a sanitary landfill disposal mode.

17. The system of claim 11, wherein the means for computing an ecological impact quantification associated with disposal of at least a portion of the product according to a product disposal mode further comprises:
means for computing an ecological impact quantification associated with disposal of at least a portion of the product according to an ocean floor disposal mode.

18. The system of claim 1, wherein the means for assigning at least one of a positive ecological impact status, a negative ecological impact status and a neutral ecological impact status with a user account according to the at least one ecological impact quantification comprises:
means for charging a fee to the user account according to the ecological impact quantification.

19. The system of claim 1, wherein the means for assigning at least one of a positive ecological impact status, a negative ecological impact status and a neutral ecological impact status with a user account according to the at least one ecological impact quantification comprises:
means for crediting a user account according to the ecological impact quantification.

20. The system of claim 1, wherein the means for assigning at least one of a positive ecological impact status, a negative ecological impact status and a neutral ecological impact status with a user account according to the at least one ecological impact quantification comprises:
means for generating a webpage indicative of the at least one of a positive ecological impact status, a negative ecological impact status and a neutral ecological impact status.

21. The system of claim 1, further comprising:
means for publishing a notification associated with the at least one of a positive ecological impact status, a negative ecological impact status and a neutral ecological impact status.

22. The system of claim 21, wherein the means for publishing a notification associated with the at least one of a positive ecological impact status, a negative ecological impact status and a neutral ecological impact status comprises:
means for generating a webpage that includes information based at least in part on the at least one of a positive ecological impact status, a negative ecological impact status and a neutral ecological impact status.

23. The system of claim 22, wherein the means for generating a webpage that includes information based at least in part on the at least one of a positive ecological impact status, a negative ecological impact status and a neutral ecological impact status comprises:
means for generating a webpage that includes a link to at least one downloadable file including information based at least in part on the at least one of a positive ecological impact status, a negative ecological impact status and a neutral ecological impact status.

24. The system of claim 21, wherein the means for publishing a notification associated with the at least one of a positive ecological impact status, a negative ecological impact status and a neutral ecological impact status comprises:
means for publishing a notification that includes information based at least in part on the at least one of a positive ecological impact status, a negative ecological impact status and a neutral ecological impact status to a social media database account associated with the user.

25. The system of claim 21, wherein the means for publishing a notification associated with the at least one of a positive ecological impact status, a negative ecological impact status and a neutral ecological impact status comprises:
means for providing an e-mail notification that includes information based at least in part on the at least one of a positive ecological impact status, a negative ecological impact status and a neutral ecological impact status to one or more e-mail accounts.

26. The system of claim 25, wherein the means for providing an e-mail notification that includes information based at least in part on the at least one of a positive ecological impact status, a negative ecological impact status and a neutral ecological impact status to one or more e-mail accounts comprises:
means for providing an e-mail including at least one attached file that includes information based at least in part on the at least one of a positive ecological impact status, a negative ecological impact status and a neutral ecological impact status to one or more e-mail accounts.

27. The system of claim 21, wherein the means for publishing a notification associated with the at least one of a positive ecological impact status, a negative ecological impact status and a neutral ecological impact status comprises:
means for providing a text messaging notification that includes information based at least in part on the at least one of a positive ecological impact status, a negative ecological impact status and a neutral ecological impact status to one or more devices.

28. The system of claim 21, wherein the means for publishing a notification associated with the at least one of a positive ecological impact status, a negative ecological impact status and a neutral ecological impact status comprises:
means for generating a printed notification that includes information based at least in part on the at least one of a positive ecological impact status, a negative ecological impact status and a neutral ecological impact status to one or more devices.

29. A computer implemented method comprising:
computing at least one ecological impact quantification associated with at least one life-cycle phase of a product; and
assigning at least one of a positive ecological impact status, a negative ecological impact status and a neutral ecological impact status with a user account according to the at least one ecological impact quantification.

30. A system comprising:
circuitry for computing at least one ecological impact quantification associated with at least one life-cycle phase of a product; and
circuitry for assigning at least one of a positive ecological impact status, a negative ecological impact status and a neutral ecological impact status with a user account according to the at least one ecological impact quantification

31. A computer-readable storage medium product storing instructions for:
computing at least one ecological impact quantification associated with at least one life-cycle phase of a product; and
assigning at least one of a positive ecological impact status, a negative ecological impact status and a neutral ecological impact status with a user account according to the at least one ecological impact quantification.
